(19) United States
(12) Patent Application Publication
(10) Pub. No.: US 2026/0319226 A1
(43) Pub. Date: Oct. 15, 2026

(54) LENS MODULE AND ELECTRONIC DEVICE

(71) Applicant: HUAWEI TECHNOLOGIES CO., LTD., Shenzhen (CN)

(72) Inventors: Danli Zhu, Shenzhen (CN); Kaiyuan Zhang, Dongguan (CN); Sichen Long, Dongguan (CN); Baoding He, Shenzhen (CN)

(73) Assignee: HUAWEI TECHNOLOGIES CO., LTD., Shenzhen (CN)

(21) Appl. No.: 19/694,791

(22) Filed: Jun. 1, 2026

Related U.S. Application Data
(63) Continuation of application No. PCT/CN2024/110608, filed on Aug. 8, 2024.

(30) Foreign Application Priority Data
Nov. 30, 2023 (CN) 202311632438.7

(51) Int. Cl. G02B 13/00; G02B 5/20; G02B 7/02; G03B 17/12; G03B 17/17; G03B 30/00; H04N 23/55

(52) U.S. Cl. CPC G02B 13/0065; G02B 5/208; G02B 7/021; G02B 13/0045; G03B 17/12; G03B 17/17; H04N 23/55; G03B 30/00

(57) ABSTRACT

A lens module includes at least a first lens group, a second lens group, a first reflection element, and a photosensitive element. After being incident from the first lens group, light is reflected by the first reflection element, and then is incident to the second lens group, and is projected onto the photosensitive element after passing through the second lens group. The first lens group may move in a plane perpendicular to an optical axis of the first lens group, to implement an image stabilization function of the lens module. The second lens group may move close to or away from the first reflection element in a first direction.

### CROSS-REFERENCE TO RELATED APPLICATIONS

The present disclosure is a continuation of International Application No. PCT/CN2024/110608, filed on Aug. 8, 2024, which claims priority to Chinese Patent Application No. 202311632438.7, filed on Nov. 30, 2023. The disclosures of the aforementioned applications are hereby incorporated by reference in their entireties.

### TECHNICAL FIELD

The present disclosure relates to the field of terminal device hardware, and specifically, to a lens module and an electronic device.

### BACKGROUND

A volume and a weight of a portable electronic device such as a mobile phone or a tablet computer are important factors that affect portability and operability of the portable electronic device. To improve photographing experience of a user, more lens modules with a larger volume are assembled in an electronic device with limited accommodation space, which limits lightness and thinness of the electronic device to some extent. How to implement more photographing functions on a same lens module, improve imaging quality of a single lens module, and on this basis, reduce a volume of the lens module as much as possible and reduce occupation of internal accommodation space of the electronic device by the lens module is a problem that needs to be considered.

### SUMMARY

The present disclosure provides a lens module. The lens module includes at least two lens groups. One lens group close to a photographed object may move in a plane perpendicular to an optical axis of the lens group, to adjust a position of an incident point of incident light on the lens module, and implement an image stabilization function of the lens module. Another lens group close to a photosensitive element may move close to or away from the photosensitive element in an optical axis direction. In a movement process of the lens group, a focal length and an image distance of the lens module change correspondingly. Therefore, an object distance of the lens module has a wider adjustment range, and the lens module can clearly photograph both a distant object and a near object.

According to a first aspect, a lens module is provided, including: a first lens group, a first reflection element, a second lens group, and a photosensitive element. The first lens group includes one or more lenses, a distance between the first lens group and the first reflection element is fixed in a first direction, the first direction is an axial direction of the first lens group, the first lens group is configured to be movable in a first plane, and the first plane is perpendicular to the first direction. The second lens group includes one or more lenses. The second lens group is configured to be movable toward or away from the first reflection element in a second direction. The second direction is an axial direction of the second lens group. The first reflection element and the photosensitive element are fixed relative to each other. Incident light is incident to the first reflection element after passing through the first lens group, is incident to the second lens group after being reflected by the first reflection element, and is incident to the photosensitive element after passing through the second lens group.

In some scenarios, a relative position relationship between the first lens group, the first reflection element, and the second lens group may also be understood as that the first lens group and the second lens group are distributed on two sides of a normal line of a reflection surface of the first reflection element.

That the second lens group is configured to be movable close to or away from the first reflection element in the second direction may also be understood as that the second lens group is configured to move away from or close to the photosensitive element in the second direction.

In some scenarios, the technical solution may be understood as that the first plane is parallel to a focal plane of the first lens group.

That the first lens group is movable in the first plane may be understood as that the first lens group can adjust a position of an incident point of incident light on the first lens group. In other words, the lens module can have an image stabilization function. Compared with a lens module in which an image sensor is used to implement an image stabilization function of the lens module, in the lens module provided in this technical solution, there may be more space between the first reflection element and the photosensitive element to accommodate the second lens group functioning for focus adjustment, and there is larger adjustment space for a quantity of lenses included in the second lens group, a thickness of the lens, a spacing between lenses, and the like. Implementation of this technical solution helps enhance an adjustment capability of the second lens group for imaging light, and helps improve imaging quality of the lens module. In addition, because fewer components are disposed on the first reflection element and the photosensitive element, this technical solution also helps reduce a volume of the lens module to some extent.

When the second lens group is close to or away from the first reflection element, a distance between the second lens group and the first lens group also changes correspondingly. In other words, if the first lens group and the second lens group are considered as a whole, a focal length of the two lens groups changes as the second lens group moves. In addition, an image distance of the lens module also changes in a movement process of the second lens group. Changes of both the focal length and the image distance help expand a change range of an object distance, and therefore, the lens module can clearly photograph a farther object and a closer object.

In addition, compared with a solution in which a focus adjustment function is implemented by moving the first lens group, in this technical solution, the provided lens module has a smaller size in a light incident direction, or in other words, a thickness of the lens module is smaller. When the lens module is installed on an electronic device, a size in a thickness direction of the electronic device is reduced.

With reference to the first aspect, in some implementations of the first aspect, the lens module further includes a first platform, the first lens group is fastened to the first platform, and the first platform is configured to drive the first lens group to move in the first plane.

The lens group is fixed on a mobile platform, and movement of the platform drives the lens group to move. This helps improve stability of a movement process of the lens group, and helps improve reliability of image stabilization performance of the lens module.

With reference to the first aspect, in some implementations of the first aspect, a focal length of the first lens group is G1, a maximum stroke of the first lens group in the first plane is 2×Ld, and G1 and Ld satisfy:

$$\frac{G 1}{L d} \geq 50.$$

In some scenarios, the maximum stroke of the first lens group may be understood as a distance between two points that are farthest from each other in a movement process of the first lens group in the first plane. Herein, the maximum stroke of the first lens group may be understood as twice an image stabilization stroke of the first lens group.

A larger maximum stroke of the first lens group indicates stronger image stabilization performance of the lens module. The maximum stroke of the first lens group provided in this technical solution can meet a requirement for image stabilization performance of the lens module in a photographing process.

With reference to the first aspect, in some implementations of the first aspect, the lens module further includes a second platform, the second lens group is fastened to the second platform, and the second platform is configured to drive the second lens group to move close to or away from the first reflection element in the second direction.

In a possible implementation, the first platform may be an electromagnetic drive platform, for example, a voice coil motor.

The lens group is fixed on a mobile platform, and movement of the platform drives the lens group to move. This helps improve stability of a movement process of the lens group, and helps improve reliability of photographing performance of the lens module.

With reference to the first aspect, in some implementations of the first aspect, a total track length of the lens module is Lt, a maximum stroke of the second lens group in the second direction is Mv, and Lt and Mv satisfy:

$$0.01 \leq \frac{M v}{L t} \leq 0 \text{.40} .$$

A larger maximum behavior of the second lens group indicates a larger adjustable range of the focal length, the image distance, and the object distance of the lens module. However, a larger stroke usually means that larger accommodation space is required. The maximum stroke of the second lens group provided in this technical solution helps to balance good photographing performance of the lens module and a small volume of the lens module.

With reference to the first aspect, in some implementations of the first aspect, the first lens group has a positive focal power.

The first lens group having a positive focal power means that a size of an image of an object after imaging by the first lens group is less than a size of the object. In other words, after entering the lens module, incident light first undergoes converge processing and then imaging. In this way, more incident light can be finally projected onto the photosensitive element, or more information of a photographed object can be captured by the lens module. Implementation of this technical solution helps improve imaging quality of the lens module.

With reference to the first aspect, in some implementations of the first aspect, an optical axis of the first lens group is perpendicular to an optical axis of the second lens group.

In this technical solution, incident light that is horizontally incident to the first lens group is perpendicularly incident to the second lens group and then is projected onto the photosensitive element. Implementation of the technical solution helps more properly arrange another optical component and the like in the lens module, and helps improve utilization efficiency of internal space of the lens module.

With reference to the first aspect, in some implementations of the first aspect, the lens module further includes a third lens group, the third lens group includes one or more lenses, the third lens group is located on a side that is of the second lens group and that is close to the first reflection element, and the third lens group and the first reflection element are fixed relative to each other.

With reference to the first aspect, in some implementations of the first aspect, the lens module further includes a fourth lens group, the fourth lens group includes one or more lenses, the fourth lens group is located on a side that is of the second lens group and that is away from the first reflection element, and the fourth lens group and the first reflection element are fixed relative to each other.

The third lens group and/or the fourth lens group are/is disposed to increase adjustable dimensions such as a propagation path and an optical distance of light that is incident to the lens module, so that imaging of the lens module on the photosensitive element is clearer, and imaging quality is improved.

With reference to the first aspect, in some implementations of the first aspect, the lens module further includes a second reflection element, the second reflection element is located on the side that is of the second lens group and that is away from the first reflection element, and the second reflection element is disposed close to the photosensitive element.

The second reflection element is disposed, so that a position of the photosensitive element in the lens module is more flexible, thereby improving utilization of space occupied by the lens module, and to some extent, helping reduce space occupied by the lens module in the optical axis direction of the second lens group.

According to a second aspect, an electronic device is provided, where the electronic device includes a middle frame and the lens module according to any one of the first aspect and the possible implementations of the first aspect, and the lens module is fastened to the middle frame.

Compared with a solution in which a focus adjustment function is implemented by moving the first lens group, in this technical solution, the provided lens module has a smaller size in a light incident direction, or in other words, a thickness of the lens module is smaller. An electronic device in which the lens module is installed has a smaller size in a thickness direction, or in other words, the electronic device is thinner.

### BRIEF DESCRIPTION OF DRAWINGS

FIG. 1 is a diagram of an electronic device according to an embodiment of the present disclosure;

FIG. 2 is a diagram of a lens module according to an embodiment of the present disclosure;

FIG. 3 is a diagram of another lens module according to an embodiment of the present disclosure;

FIG. 4 is a diagram of several lens forms according to an embodiment of the present disclosure;

FIG. 5 is a diagram of still another lens module according to an embodiment of the present disclosure;

FIG. 6 is a diagram of still another lens module according to an embodiment of the present disclosure;

FIG. 7 is a diagram of still another lens module according to an embodiment of the present disclosure;

FIG. 8 is a diagram of still another lens module according to an embodiment of the present disclosure;

FIG. 9 is a diagram of still another lens module according to an embodiment of the present disclosure;

FIG. 10 is a diagram of an imaging process of a lens module according to an embodiment of the present disclosure; and

FIG. 11 is a diagram of another imaging process of a lens module according to an embodiment of the present disclosure.

### DESCRIPTION OF EMBODIMENTS

The following describes embodiments of the present disclosure in detail. Examples of embodiments of the present disclosure are shown in the accompanying drawings. In the accompanying drawings, same or similar reference numerals indicate same or similar elements or elements having same or similar functions. The following embodiments described with reference to the accompanying drawings are examples, and are merely intended to explain the embodiments present disclosure, but should not be construed as a limitation.

Unless otherwise defined, a technical term or a scientific term used herein shall have a general meaning understood by a person of ordinary skill in the technical field of the present disclosure. In descriptions of the present disclosure, it should be understood that orientations or position relationships indicated by terms such as “center”, “longitudinal”, “lateral”, “up”, “down”, “front”, “back”, “left”, “right”, “vertical”, “horizontal”, “top”, “bottom”, “inside”, and “outside” are orientations or position relationships that are shown based on the accompanying drawings, and are merely intended to facilitate the descriptions of the present disclosure and simplify the descriptions, but are not intended to indicate or imply that an indicated apparatus or element needs to have a specific orientation or needs to be constructed and operated in a specific orientation, and therefore cannot be understood as a limitation on the present disclosure.

Reference to “an embodiment”, “some embodiments”, or the like described in this specification indicates that one or more embodiments of the present disclosure include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized in another manner.

Before embodiments of the present disclosure are formally described, terms that may be used in the following content are first described.

F number/aperture, or F # or F-number, is a relative value (a reciprocal of a relative aperture) obtained by dividing a focal length of a lens by a light transmission diameter of the lens. A smaller F number of the aperture indicates more light entering the lens in a same unit time. A larger F number of the aperture indicates a smaller depth of field, and background blur occurs in photographing. This effect is similar to that of a telephoto lens.

A stop is an entity in an optical system to limit a light beam, and may be an edge, a frame, or a specially disposed barrier with a hole of a lens.

A focal length is a distance from a lens center to a focal point at which light focuses. For a system formed by a rear lens, a plurality of lenses, or a mirror lens, a focal length is usually represented by an effective focal length (effective focal length, EFL).

A total track length (total track length, TTL) generally is a distance from a surface of an image sensor to a top of a lens. The TTL is a main factor that forms a height of a lens module.

Image height (image height, IH): A radius of an image circle is a half of image height.

A field of view (field of view, FOV) is a scope of an “observable world” that can be seen by a vision or an apparatus at any given moment. In an optical instrument, an included angle formed by a lens of the optical instrument as a vertex and two edges of a maximum range that is of an object image of a measured target and that can pass through the lens is referred to as a field of view.

An image circle (image circle, IC) is a cross section of a light cone formed after light is transmitted to an image plane through a lens or a series of lenses. For a system with an adjustable image circle, a maximum image circle (max image circle, MIC) is one with a largest diameter in a plurality of image circles.

A back focal length (back focal length, BFL) is a distance between a last optical surface vertex and a back focus in an optical system.

A modulation transfer function (modulation transfer function, MTF) is modulation contrast and is an evaluation metric of imaging quality of a system.

A chief ray is a ray passing through centers of an entrance pupil and an exit pupil of a system.

A chief ray angle (chief ray angle, CRA) is an incident angle of a chief ray on an image plane.

A positive focal power indicates that a lens or a lens group has a positive focal length and an effect of converging light.

A negative focal power indicates that a lens or a lens group has a negative focal length and an effect of diverging light.

A focusing distance is a distance between a photographed object and a focal plane on an image side. A shortest focusing distance is a shortest distance at which a lens can achieve focusing on the photographed object. When a distance between a focal plane of the photographed object and a focal plane of a lens module is less than the shortest focusing distance, the lens cannot achieve focusing. When the distance between the focal plane of the photographed object and the focal plane of the lens module is greater than or equal to the shortest focusing distance, the lens can achieve focusing.

A photosensitive element, or referred to as an image sensor, is a device that converts an optical image into an electronic signal, and is widely used in a digital camera and another electronic optical device. In the past, an image sensor used an analog signal, such as a video camera (video camera tube). Nowadays, image sensors are mainly divided into a charge-coupled device (charge-coupled device, CCD) and a complementary metal-oxide semiconductor (complementary metal-oxide semiconductor, CMOS) active pixel sensor (active pixel sensor).

An infrared cut-off filter, also referred to as an infrared filter or a heat absorbing filter, is a filter configured to filter out an infrared band. For example, the infrared cut-off filter may be installed on a device with an incandescent lamp (such as a slide or a projector) to prevent unnecessary heat from burning a lens, and may be installed on a camera of a solid-state electronic component (CCD or CMOS) to prevent an infrared ray from passing through a lens of the camera and causing image distortion.

An Abbe number (Abbe number) is used to measure light dispersion of a medium. The Abbe number is originally used to measure properties of optical glass, and is also applicable to other transparent materials such as polyester resin and polycarbonate commonly used in eyeglass lenses.

A refractive index (refractive index) is a ratio of a velocity of light (velocity of light) in a vacuum to a phase velocity of light entering a medium. The refractive index determines a degree of bending or refraction of a light path when light enters a material.

Distant-view photographing and macro photographing are two photographing manners that are frequently used by a photographing apparatus such as an electronic device or a camera. To make an object photographed in a distant-view photographing state (referred to as a first photographing state or a long-focal-length photographing mode) clear enough, a lens module needs to have a long object distance. To make an object photographed in a macro photographing state (referred to as a second photographing state or a macro photographing mode) clear enough, the lens module needs to have a short minimum focusing distance. Lightweighting and thinning is a development direction of a portable electronic device such as a mobile phone. A volume of a lens module is usually an important factor that restricts size factors such as a volume and a thickness of the electronic device. To implement functions of both distant-view photographing and macro photographing while reducing the volume of the lens module, embodiments of the present disclosure provide a lens module and an electronic device, which are described in the following.

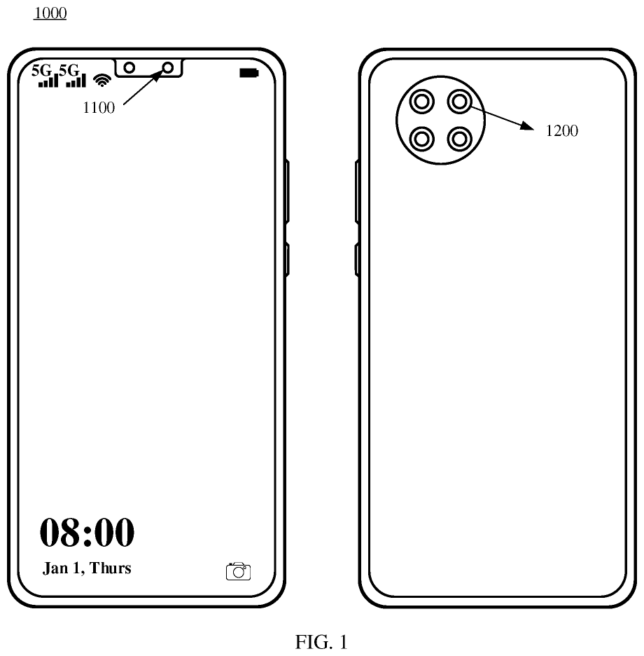

FIG. 1 shows an electronic device 1000 according to an embodiment of the present disclosure. The electronic device 1000 may include a front-facing camera module 1100 and/or a rear-facing camera module 1200. A lens module provided in the present disclosure may be applied to the front-facing camera module 1100 or the rear-facing camera module 1200. In some examples, the electronic device 1000 includes a middle frame, and the front-facing camera module 1100 and/or the rear-facing camera module 1200 may be fastened to the middle frame, to be installed in the electronic device 1000.

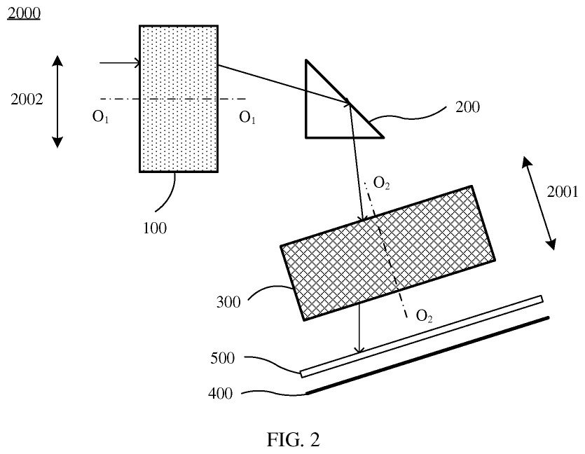

FIG. 2 shows a first lens module 2000 according to an embodiment of the present disclosure. The first lens module 2000 may be the front-facing camera module 1100 or the rear-facing camera module 1200. The first lens module 2000 may include a plurality of lens groups and at least one reflection element. In the plurality of lens groups, one lens group may implement an image stabilization function of the first lens module 2000, another lens group may implement a focus adjustment function of the first lens module 2000, and the at least one reflection element may be configured to adjust a propagation path of light in the first lens module 2000.

In some examples, the first lens module 2000 may include a first lens group 100, a second lens group 300, a first reflection element 200, and a photosensitive element 400. Light incident to the first lens module 2000 is incident to the first reflection element 200 after passing through the first lens group 100, is incident to the second lens group 300 after being reflected by the first reflection element 200, and is projected onto the photosensitive element 400 after passing through the second lens group 300.

In some examples, the first lens module 2000 further includes an infrared cut-off filter 500. The infrared cut-off filter 500 is located between the second lens group 300 and the photosensitive element 400, and is disposed close to the photosensitive element 400. Light emergent from the second lens group 300 is filtered by the infrared cut-off filter 500 and then projected onto the photosensitive element 400.

In some examples, the first lens module 2000 further includes a stop. The stop may be disposed on a side that is of the first lens group 100 and that is away from the first reflection element 200. The stop may be configured to adjust a size of a light beam incident to the first lens group 100.

As shown in FIG. 2, the first reflection element 200 may be located between the first lens group 100 and the second lens group 300, and the second lens group 300 may be located between the first reflection element 200 and the photosensitive element 400.

In some examples, the second lens group 300 may move close to or away from the first reflection element 200 in a first direction 2001, or in other words, the second lens group 300 may move away from or close to the photosensitive element 400 in the first direction 2001.

For example, the first direction 2001 may be a second axial direction O₂O₂ of the second lens group 300. In some scenarios, the first direction 2001 may also be referred to as the second axial direction O₂O₂.

By way of example rather than limitation, the first lens module 2000 may include a first platform (not shown in the figure), the second lens group 300 may be fastened to the first platform, the first platform may be a movable platform, and the movable platform may be configured to drive the second lens group 300 to move close to or away from the first reflection element 200 in the first direction 2001.

There should be a specific moving distance or activity space between the first reflection element 200 and the photosensitive element 400, so that the second lens group 300 can move in the first direction 2001 in the activity space.

If the first lens group 100 and the second lens group 300 are considered as a whole, in a process in which the second lens group 300 moves in the first direction 2001, an overall focal length of the first lens group 100 and the second lens group 300 changes, and an overall image distance of the first lens group 100 and the second lens group 300 also changes. The focal length, an object distance, and the image distance satisfy an imaging relationship. Therefore, changes of the focal length and the image distance provide adjustment space for the object distance of the first lens module 2000. In other words, the object distance of the first lens module 2000 has a wider adjustment range.

Compared with a solution in which a focus adjustment function is implemented by moving the first lens group, in this technical solution, the provided lens module has a smaller size in a light incident direction, or in other words, a thickness of the lens module is smaller. When the lens module is installed on an electronic device, a size in a thickness direction of the electronic device is reduced.

A larger stroke by which the second lens group 300 moves in the first direction 2001 indicates a wider adjustable range of the focal length, the object distance, and the image distance of the first lens module 2000. A wider adjustable range of the object distance indicates a wider range of distances from a far object to a near object that can be clearly photographed by the first lens module 2000. In other words, the first lens module 2000 can clearly photograph a farther object and a closer object.

In some examples, a maximum stroke by which the second lens group 300 moves in the first direction 2001 is Mv, a total track length of the first lens module 2000 is Lt, and Lt and Mv may satisfy:

$$0.01 \leq \frac{M v}{L t} \leq 0 \text{.40} .$$

For example, Mv may be 0.05 Lt, 0.1 Lt, 0.2 Lt, or 0.3 Lt.

In some examples, a magnification rate of the lens module in the second photographing state is β, and 0.1≤β≤0.5.

In some examples, the first lens group 100 is configured to move in a first plane 2002. For example, the first plane 2002 may be perpendicular to a first axial direction O₁O₁ of the first lens group 100. In other words, the first plane 2002 is parallel to a focal plane of the first lens group 100.

For example, the first lens module 2000 may include a second platform (not shown in the figure), the first lens group 100 may be fastened to the second platform, the second platform may be a movable platform, and the movable platform may be configured to drive the first lens group 100 to move in the first plane 2002.

The first lens group 100 may move from an initial position (or referred to as a displacement zero) to another position in the first plane 2002. If a distance between a farthest point to which the first lens group 100 can move in the first plane 2002 and the initial position is denoted as Ld, a maximum stroke of the first lens group 100 in the first plane 2002 may be denoted as 2×Ld. A larger maximum stroke corresponding to the first lens group 100 indicates a larger adjustable region range of a position of an incident point at which light is incident on the first lens group 100. It may be understood as that the first lens module 2000 has stronger image stabilization performance.

In some examples, a focal length of the first lens group 100 may be denoted as G1, and G1 and Ld may satisfy:

$$\frac{G 1}{L d} \geq 50.$$

For example, G1 may be 60 Ld, 80 Ld, 100 Ld, or 120 Ld.

In some examples, an image stabilization angle in the image stabilization feature of the lens module is γ, and 0.5°<γ<3.0°.

In some examples, the first lens group 100 has a positive focal power, or in other words, incident light is incident to the first lens group 100 and then is emergent, and emergent light is more converged than the incident light.

The first lens group 100 may include one or more lenses, and adjustment of incident light by the first lens group 100 may be determined based on a composite result of adjustment of the incident light by the one or more lenses.

For a same lens, attributes of surfaces on two sides of the lens, a thickness of the lens, a material of the lens, and the like jointly determine a propagation path and a propagation optical distance of incident light in the lens. The attribute of the surface of the lens may include a type of the surface, a curvature radius of the surface (or a degree of convexity and concavity of the surface), and the like. Different lens materials may correspond to different refractive indexes of light. By adjusting the material of the lens and the thickness of the lens, deflection of incident light in a direction of the lens perpendicular to an optical axis can be adjusted, to adjust a position of an emergent point of the light on the lens.

For a lens group including a plurality of lenses, an adjustment function of the lens group on incident light is further related to a spacing between two adjacent lenses in the plurality of lenses.

Therefore, a propagation path and/or a propagation optical distance of incident light in the first lens module 2000 can be adjusted to adjust a final imaging effect of the first lens module 2000 by adjusting one or more of the following of the first lens group 100 and/or the second lens group 300:
a quantity of lenses in a lens group, a spacing between two adjacent lenses in a lens group including a plurality of lenses, a thickness of each lens in a lens group, a surface attribute of each lens in a lens group, or a material of each lens in a lens group.

In some examples, the lens module further includes a third lens group, the third lens group includes one or more lenses, the third lens group is located on a side that is of the second lens group and that is close to the first reflection element, and the third lens group and the first reflection element are fixed relative to each other.

In some examples, the lens module further includes a fourth lens group, the fourth lens group includes one or more lenses, the fourth lens group is located on a side that is of the second lens group and that is away from the first reflection element, and the fourth lens group and the first reflection element are fixed relative to each other.

The third lens group and/or the fourth lens group are/is disposed to increase adjustable dimensions such as a propagation path and an optical distance of light that is incident to the lens module, so that imaging of the lens module on the photosensitive element is clearer, and imaging quality is improved.

In some examples, the lens module further includes a second reflection element, the second reflection element is located on the side that is of the second lens group and that is away from the first reflection element, and the second reflection element is disposed close to the photosensitive element.

The second reflection element is disposed, so that a position of the photosensitive element in the lens module is more flexible, thereby improving utilization of space occupied by the lens module, and to some extent, helping reduce space occupied by the lens module in the optical axis direction of the second lens group.

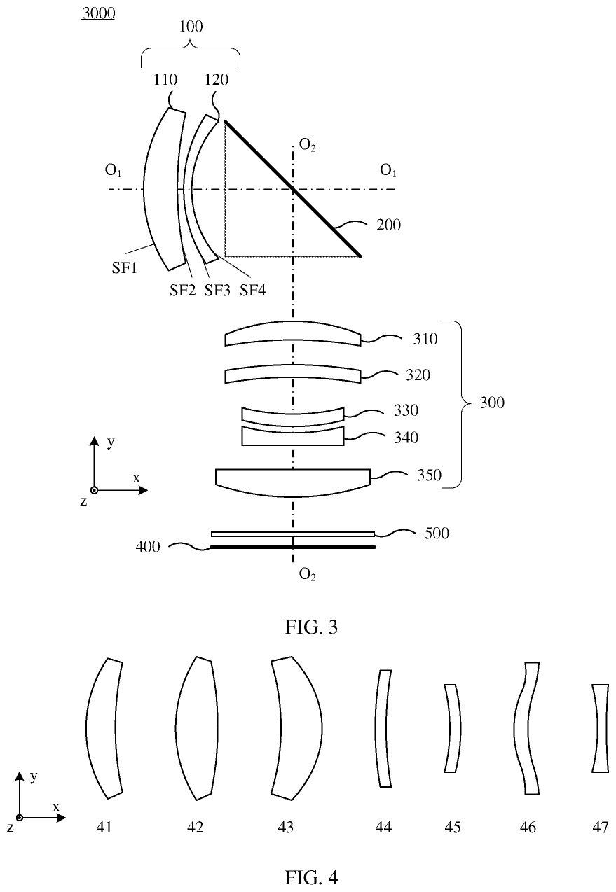

FIG. 3 shows a second lens module 3000 according to an embodiment of the present disclosure. The second lens module 3000 may include the first lens group 100, the first reflection element 200, the second lens group 300, and the photosensitive element 400 in the foregoing first lens module 2000. Light is incident to a surface of the first reflection element 200 through the first lens group 100, is incident to the second lens group 300 after being reflected by the first reflection element 200, and is projected onto the photosensitive element 400 after passing through the second lens group 300.

In some examples, the second lens module 3000 may further include an infrared cut-off filter 500. The infrared cut-off filter 500 is located between the second lens group 300 and the photosensitive element 400, and is disposed close to the photosensitive element 400. Light emergent from the second lens group 300 is filtered by the infrared cut-off filter 500 and then is incident to the photosensitive element 400. Disposing of the infrared cut-off filter 500 helps prevent an infrared ray in the incident light from being incident to the photosensitive element 400, and helps improve imaging quality of the second lens module 3000.

In some examples, the second lens module 3000 further includes a stop. The stop may be disposed on a side that is of the first lens group 100 and that is away from the first reflection element 200. The stop may be configured to adjust a size of a light beam incident to the first lens group 100.

In some examples, the first optical axis O₁O₁ of the first lens group 100 may be inclined to a reflection surface RP1 of the first reflection element 200, the second optical axis O₂O₂ of the second lens group 300 may be inclined to the reflection surface RP1 of the first reflection element 200, and light emergent from the first lens group 100 may be incident to the second lens group 300 after being reflected by the first reflection element 200. For example, the first optical axis O₁O₁ of the first lens group 100 and the second optical axis O₂O₂ of the second lens group 300 may be perpendicular to each other.

In some examples, the first reflection element 200 may be one or more of a planar reflector, a right-angle prism reflector, an off-axis parabolic reflector, a hollow ridge prism reflector, or the like. For example, the first reflection element 200 may be a right-angle prism reflection element.

A shape and a size of the first reflection element 200, a distance between the first reflection element 200 and the first lens group 100, and a distance between the first reflection element 200 and the second lens group 300 may affect a propagation path of incident light in the second lens module 3000, and the like, thereby affecting imaging quality of the lens module.

For example, the first reflection element 200 is a diameter prism reflection element. A thickness of the first reflection element 200 may be denoted as hr1, and hr1 may satisfy: 1.00 mm≤hr1≤10.00 mm. For example, hr1 may be 3.00 mm, 5.00 mm, 6.00 mm, 6.50 mm, 7.00 mm, 8.00 mm, or 9.00 mm.

For example, the first reflection element 200 is a diameter prism reflection element. A spacing between the first reflection element 200 and the first lens group 100 and a spacing between the first reflection element 200 and the second lens group 300 may be respectively denoted as Dr1 and Dr2.

In some examples, Dr1 may satisfy 0.01 mm≤Dr1≤3.0 mm. For example, Dr1 may be 0.02 mm, 0.03 mm, 0.60 mm, 0.09 mm, 0.12 mm, 0.50 mm, 1.20 mm, 1.80 mm, or 2.40 mm.

In some examples, Dr2 may satisfy 1.0 mm≤Dr2≤4.0 mm. For example, Dr2 may be 1.50 mm, 1.80 mm, 2.10 mm, 2.40 mm, 3.20 mm, 3.60 mm, 3.80 mm, or the like.

A propagation path of light in the lens module is adjusted by using the reflection element. When the lens module is installed in an electronic device with limited accommodation space, the reflection element is disposed to help properly arrange positions of elements such as a lens group in the lens module, and help improve space utilization efficiency inside the electronic device.

In some examples, the first lens group 100 may move in an image stabilization plane, or one or more lenses in the first lens group 100 may move in the image stabilization plane, and the image stabilization plane may be perpendicular to the first optical axis O₁O₁ of the first lens group 100. A coordinate axis shown in FIG. 3 is used as an example. The first optical axis O₁O₁ is parallel to an x axis, and the one or more lenses in the first lens group 100 may move in a y-z plane, or in other words, the image stabilization plane is the y-z plane.

In some examples, the second lens module 3000 further includes a first drive platform. The lens in the first lens group 100 may be fastened to the first drive platform (for example, installed on the first drive platform), and the first drive platform may drive the first lens group 100 to move in the drive plane in a moving process. For example, the first drive platform may include a voice coil motor (voice coil motor, VCM). When a magnitude of a current input to the voice coil motor changes, a moving distance of the first drive platform or the first lens group 100 in a moving direction may be correspondingly adjusted, to implement an image stabilization function.

In some examples, the first lens group 100 may have a positive focal power. In other words, after light is incident to the first lens group 100, emergent light is more converged than the incident light. The first lens group 100 may include one or more lenses.

When the first lens group 100 includes only one lens, the lens has a positive focal power, and an optical axis of the lens is the first optical axis O₁O₁ of the first lens group 100.

When the first lens group 100 may include a plurality of lenses, the plurality of lenses have a same first optical axis O₁O₁. The plurality of lenses may be arranged along the first optical axis O₁O₁. When incident light is emergent through the plurality of lenses, emergent light is more converged than the incident light. In other words, if the plurality of lenses are considered as a whole, the plurality of lenses have a positive focal power as a whole.

Compared with disposing only one lens in the first lens group 100, including more lenses in the first lens group 100 helps increase a dimension of adjusting incident light by the first lens group 100, improve an effect of modulating the incident light by the first lens group 100, and improve imaging quality of the lens module. However, a larger quantity of lenses increases a volume of the first lens group 100 to some extent, and increases space occupied by the lens module.

In some examples, the first lens group 100 may include two coaxial lenses. Adjustment of incident light by the first lens group 100 can be implemented by adjusting a spacing between the two lenses and an attribute of each of the two lenses.

When the first lens group 100 includes a plurality of lenses, each of the plurality of lenses may have a different convergence or divergence function on light.

For example, as shown in FIG. 3, the first lens group 100 may include a first lens 110 and a second lens 120. The first lens 110 may have a positive focal power, and the second lens 120 may have a negative focal power. Herein, the first lens 110 may be disposed away from the first reflection element 200, and the second lens 120 may be disposed close to the first reflection element 200.

Similarly, for example, the first lens group 100 may include a first lens, a second lens, and a third lens. The first lens may have a positive focal power, the second lens may have a negative focal power, and the third lens may have a positive focal power or a negative focal power. Herein, the first lens, the second lens, and the third lens are sequentially arranged along the first optical axis O₁O₁ in a direction close to the first reflection element 200.

A light convergence or divergence capability of a lens is related to a surface shape of the lens, a thickness of the lens, a material of the lens, and the like.

In some examples, a surface shape of one or more lenses in the first lens group 100 may be a spherical surface or an aspheric surface.

For example, when the first lens group 100 includes the first lens 110 and the second lens 120, surfaces on two sides of either of the first lens 110 and the second lens 120 may be spherical surfaces or aspheric surfaces, or one of the surfaces on the two sides is a spherical surface and the other is an aspheric surface. For example, the surfaces on the two sides of each of the first lens 110 and the second lens 120 may be aspheric surfaces.

Similarly, for example, when the first lens group 100 includes more than two lenses, two opposite surfaces of each lens may be spherical surfaces or aspheric surfaces. This is not limited in the present disclosure.

In some examples, for a lens of an aspheric shape, a surface of the lens may be determined according to the following formula:

$$Z = \frac{c \times {r}^{2}}{1 + \sqrt{1 - ( 1 + k ) \times {c}^{2} \times {r}^{2}}} + {\sum }_{n = 1}^{n} {A}_{I} {E}_{I} ( x , y ) \qquad ( 1 )$$

where a parameter c=1/R, that is, a curvature corresponding to a radius; r is a distance from a point on an optical surface to an optical axis; z represents a vector height of the point in an optical axis direction; k is a quadratic surface coefficient of the surface, I is an aspheric coefficient term, and for example, I may be 30; and A_{I} is an aspheric coefficient.

A divergence or convergence function of a lens on a same light beam can be changed by changing convexity and concavity of surfaces on two sides of the lens. FIG. 4 shows lenses with different surface attributes according to an embodiment of the present disclosure. Convexity and concavity of the lens in the first lens group 100 may be specifically designed based on performance of the first lens group 100. This is not limited in the present disclosure.

In FIG. 4, the lens 41, the lens 42, and the lens 43 all have a positive focal power, and the lens 44, the lens 45, the lens 46, and the lens 47 all have a negative focal power. A curved surface opening facing a positive direction of an x-axis indicates a positive curvature, and a curved surface opening facing a negative direction of the x-axis indicates a negative curvature. Both sides of the lens 41 are positive curvature surfaces, a left side of the lens 42 is a positive curvature surface, a right side of the lens 42 is a negative curvature surface, and both sides of the lens 43 are negative curvature surfaces. Both sides of each of the lens 44 and the lens 46 are positive curvature surfaces, both sides of the lens 45 are negative curvature surfaces, a left side of the lens 47 is a negative curvature surface, and a right side of the lens 47 is a positive curvature surface.

In other words, for a lens with a positive focal power, surfaces on both sides of the lens may be positive curvature surfaces or negative curvature surfaces, or the surface on one side is a positive curvature surface and the surface on the other side is a negative curvature surface. Similarly, for a lens with a negative focal power, surfaces on both sides of the lens may be positive curvature surfaces or negative curvature surfaces, or the surface on one side is a positive curvature surface and the surface on the other side is a negative curvature surface.

FIG. 4 provides only some types of lenses applicable to the first lens group 100 as an example. It should be understood that more types of lenses are also applicable to the first lens group 100. This is not limited in this embodiment of the present disclosure.

By adjusting sizes of curvature radii of surfaces on both sides of a lens, a divergence or convergence function of the lens on incident light can be changed. A size of a curvature radius of the lens in the first lens group 100 may be specifically designed based on performance of the first lens group 100. This is not limited in the present disclosure.

In some examples, refer to FIG. 3. A case in which the first lens group 100 includes the first lens 110 and the second lens 120 is used as an example. Four surfaces from a side away from the first reflection element 200 to a side close to the first reflection element 200 may be respectively referred to as a first surface SF1, a second surface SF2, a third surface SF3, and a fourth surface SF4.

For example, curvature radii of the first surface SF1, the second surface SF2, the third surface SF3, and the fourth surface SF4 may be approximately 9 mm, 90 mm, 15 mm, and 8 mm respectively.

For example, curvature radii of the first surface SF1, the second surface SF2, the third surface SF3, and the fourth surface SF4 may be approximately 11 mm, 1600 mm, 21 mm, and 10 mm respectively.

For example, curvature radii of the first surface SF1, the second surface SF2, the third surface SF3, and the fourth surface SF4 may be approximately −22 mm, −9 mm, −10 mm, and −11 mm respectively, where a negative value of the curvature radius indicates that the surface is a negative curvature surface.

For example, curvature radii of the first surface SF1, the second surface SF2, the third surface SF3, and the fourth surface SF4 may be approximately 15 mm, −100 mm, 33 mm, and 13 mm respectively, where a negative value of the curvature radius indicates that the surface is a negative curvature surface.

By adjusting a thickness of a lens, an offset distance of incident light in a direction perpendicular to an optical axis can be changed, so that a position of an emergent point of the incident light on the lens can be changed, and a propagation path of the light in the first lens group 100 can be adjusted. A thickness of the lens in the first lens group 100 may be specifically designed based on performance of the first lens group 100. This is not limited in the present disclosure.

For example, the first lens group 100 includes the first lens 110 and the second lens 120.

For example, a thickness of the first lens 110 is denoted as h1, and h1 may satisfy 1.0 mm≤h2≤4.0 mm. For example, h1 may be 1.50 mm, 2.00 mm, 2.50 mm, or 3.00 mm. A thickness of the second lens 120 is denoted as h2, and h2 may satisfy 0.1 mm≤h2≤0.6 mm. For example, h2 may be 0.20 mm, 0.25 mm, 0.30 mm, 0.45 mm, or 0.55 mm.

For a lens group including a plurality of lenses, a divergence or convergence capability of the entire lens group on incident light is not only related to an attribute (for example, a surface shape and a curvature radius of a lens) of each lens in the lens group, but also related to an arrangement manner of the plurality of lenses in the lens group. Specifically, for a form in which the plurality of lenses in the lens group are arranged along an optical axis, the divergence or convergence capability of the entire lens group on incident light is related to a distance between two adjacent lenses. By adjusting a spacing between two adjacent lenses, an overall focal length of the lens group can be adjusted to some extent. In addition, by adjusting a distance between lenses on two sides of the lens group, a propagation path of incident light in the lens group can also be affected to some extent, and a position of an emergent point after the incident light passes through the lens group is affected.

For example, the first lens group 100 includes the first lens 110 and the second lens 120.

For example, a distance between the first lens 110 and the second lens 120 is denoted as D1, and D1 may satisfy: 0.01 mm≤D1≤2.00 mm. For example, D1 may be 0.03 mm, 0.06 mm, 0.10 mm, 1.00 mm, or 1.50 mm.

Changing a material of a lens can change a refractive index of the lens for light, and therefore, a refraction angle of incident light in the lens is different. Therefore, changing the material of the lens can also adjust a propagation path of the incident light in the lens to some extent. A material or a refractive index of the lens in the first lens group 100 may be specifically designed based on performance of the first lens group 100. This is not limited in the present disclosure.

In some examples, the first lens group 100 includes a plurality of lenses, and the plurality of lenses may be made of glass or plastic, for example, polymethyl methacrylate, polycarbonate, or cyclic olefin polymer.

Factors such as a propagation path of incident light in a lens can be adjusted by selecting lens materials with different refractive indexes and Abbe numbers, thereby affecting an imaging effect of the lens module.

In some examples, a refractive index of one or more lenses included in the first lens group 100 is n1, and n1 satisfies 1.5000≤n1≤1.80000. For example, n1 may be 1.55000, 1.60000, 1.65000, 1.70000, or 1.80000.

In some examples, an Abbe number of one or more lenses included in the first lens group 100 is V1, and V1 satisfies 15.00≤V1≤60.00. For example, V1 may be 20.00, 25.00, 30.00, 40.00, 50.00, or 55.00.

The second lens group 300 may move in a focus adjustment direction, or in other words, one or more lenses in the second lens group 300 may move in the focus adjustment direction. The focus adjustment direction may be consistent with the direction of the second optical axis O₂O₂ of the second lens group 300. In this case, the foregoing solution may also be understood as follows: The second lens group 300 or the lens in the second lens group 300 may move along the second optical axis O₂O₂ in a direction close to or away from the first reflection element 200, or the second lens group 300 may move along the second optical axis O₂O₂ in a direction toward or away from the photosensitive element 400.

In a process of the second lens group 300 moves along the second optical axis O₂O₂, an incident position of light emergent from the first reflection element 200 on the second lens group 300 changes, and a position of an emergent point of the light on a surface that is of the second lens group 300 and that is close to the photosensitive element 400 changes. In addition, an optical distance along which light is propagated to the photosensitive element 400 after being emergent from the second lens group 300 changes, or in other words, an imaging distance of the second lens module 3000 changes, and a position of an incident point of the light on the photosensitive element 400 also changes correspondingly. In this way, the second lens group 300 may move along the second optical axis O₂O₂ to implement a focus adjustment function of the second lens module 3000.

In some examples, the second lens module 3000 may further include a second drive platform, and the second drive platform may drive the second lens group 300 to move along the second optical axis O₂O₂. For example, the lens in the second lens group 300 may be fastened to the second drive platform (for example, installed on the second drive platform), and in a process of moving along the second optical axis O₂O₂, the second drive platform may drive the lens in the second lens group 300 to move along the second optical axis O₂O₂. For example, the second drive platform may include a voice coil motor. Driven by the voice coil motor, the second drive platform moves along the second optical axis O₂O₂.

The first reflection element 200 and the photosensitive element 400 should have specific accommodation space in the direction of the second optical axis O₂O₂, and a distance between the accommodation space on the second optical axis O₂O₂ should be greater than a distance between a lens on a side that is of the second lens group 300 and that is close to the first reflection element 200 and a lens on a side that is of the second lens group 300 and that is close to the photosensitive element 400, so that the second lens group 300 has specific moving space in the direction of the second optical axis O₂O₂. Larger moving space indicates a wider adjustable range of the focus of the second lens group 300 or the second lens module 3000.

In some examples, the second lens group 300 may have a positive focal power, or in other words, when light incident to the second lens group 300 is emergent from the second lens group 300, emergent light is more converged than the incident light.

When the second lens group 300 includes one lens, the lens has a positive focal power, and an optical axis of the lens is the second optical axis O₂O₂ of the second lens group 300.

When the second lens group 300 includes a plurality of lenses, the plurality of lenses have a same second optical axis O₂O₂. The plurality of lenses may be arranged along the second optical axis O₂O₂. When incident light is emergent through the plurality of lenses, emergent light is more converged than the incident light. In other words, if the plurality of lenses are considered as a whole, the plurality of lenses have a positive focal power as a whole.

In some examples, the second lens group 300 may have a negative focal power, or in other words, when light incident to the second lens group 300 is emergent from the second lens group 300, emergent light is more diverged than the incident light.

When the second lens group 300 includes one lens, the lens has a negative focal power, and an optical axis of the lens is the second optical axis O₂O₂ of the second lens group 300.

When the second lens group 300 includes a plurality of lenses, the plurality of lenses have a same second optical axis O₂O₂. The plurality of lenses may be arranged along the second optical axis O₂O₂. When incident light is emergent through the plurality of lenses, emergent light is more diverged than the incident light. In other words, if the plurality of lenses are considered as a whole, the plurality of lenses have a negative focal power as a whole.

When the second lens group 300 includes a plurality of lenses, each of the plurality of lenses may have a different divergence or convergence function on light.

In some examples, as shown in FIG. 3, the second lens group 300 may include five lenses, that is, a fourth lens 310, a fifth lens 320, a sixth lens 330, a seventh lens 340, and an eighth lens 350. The five lenses may have different divergence or convergence functions on incident light.

For example, the fourth lens 310, the seventh lens 340, and the eighth lens 350 may have positive focal powers, and the fifth lens 320 and the sixth lens 330 may have negative focal powers.

Similarly, for example, the fourth lens 310 and the eighth lens 350 may have positive focal powers, and the fifth lens 320, the sixth lens 330, and the seventh lens 340 may have negative focal powers.

In some examples, the second lens group 300 may include two lenses, three lenses, four lenses, more than five lenses, or the like. This is not limited in this embodiment of the present disclosure. For second lens groups 300 having different quantities of lenses, a positive focal power or a negative focal power of each lens may also be designed based on an overall performance requirement of the second lens module 3000, and combinations thereof are also diversified. This is not limited in this embodiment of the present disclosure.

Compared with disposing only one lens in the second lens group 300, including more lenses in the second lens group 300 helps increase a dimension of adjusting incident light by the second lens group 300, improve an effect of modulating the incident light by the second lens group 300, and improve imaging quality of the lens module. However, a larger quantity of lenses increases a volume of the second lens group 300 to some extent, and increases space occupied by the lens module.

In some examples, the second lens group 300 may include five coaxial lenses. Adjustment of incident light by the second lens group 300 can be implemented by adjusting a spacing between the two lenses and an attribute of each of the two lenses.

A light convergence or divergence capability of a lens is related to a surface shape of the lens, a thickness of the lens, a material of the lens, and the like.

In some examples, a surface shape of one or more lenses in the second lens group 300 may be a spherical surface or an aspheric surface.

For example, when the second lens group 300 includes five lenses, surfaces on two sides of each of the five lenses may be spherical surfaces or aspheric surfaces, or the surface on one side of the two sides is a spherical surface and the surface on the other side is an aspheric surface.

Similarly, for example, when the second lens group 300 includes one lens, two lenses, three lenses, four lenses, or more than five lenses, two opposite surfaces of each lens may be spherical surfaces or aspheric surfaces. This is not limited in the present disclosure.

In some examples, for a lens of an aspheric shape, a surface of the lens may alternatively be determined according to the foregoing formula (1).

A divergence or convergence function of a lens on a same light beam can be changed by changing convexity and concavity of surfaces on two sides of the lens. FIG. 4 shows lenses with different surface attributes according to an embodiment of the present disclosure. Descriptions of different types of lenses in FIG. 4 are not described herein again. For detailed descriptions, refer to the foregoing description. It should be noted that different types of lenses shown in FIG. 4 and more types of lenses not shown in FIG. 4 may be applied to the second lens group 300.

By adjusting sizes of curvature radii of surfaces on both sides of a lens, a divergence or convergence function of the lens on incident light can be changed.

In some examples, refer to FIG. 3. For example, the second lens group 300 includes five lenses: the fourth lens 310, the fifth lens 320, the sixth lens 330, the seventh lens 340, and the eighth lens 350.

For example, curvature radii of two opposite surfaces of the fourth lens 310, the fifth lens 320, the sixth lens 330, the seventh lens 340, and the eighth lens 350 may be approximately 6 mm, 7 mm, 12 mm, 31 mm, 8 mm, 5 mm, 5 mm, 12 mm, 100 mm, and 8 mm respectively.

For example, curvature radii of two opposite surfaces of the fourth lens 310, the fifth lens 320, the sixth lens 330, the seventh lens 340, and the eighth lens 350 may be approximately 6 mm, 8 mm, 11 mm, 18 mm, 8 mm, 5 mm, 4 mm, 9 mm, 373 mm, and 9 mm respectively.

For example, curvature radii of two opposite surfaces of the fourth lens 310, the fifth lens 320, the sixth lens 330, the seventh lens 340, and the eighth lens 350 may be approximately 6 mm, 10 mm, 8 mm, 9 mm, 7 mm, 3 mm, 4 mm, 10 mm, 26 mm, and 7 mm respectively.

For example, curvature radii of two opposite surfaces of the fourth lens 310, the fifth lens 320, the sixth lens 330, the seventh lens 340, and the eighth lens 350 may be approximately 7 mm, 12 mm, 7 mm, 8 mm, 15 mm, 10 mm, 8 mm, 23 mm, 10 mm, and 6 mm respectively.

By adjusting a thickness of a lens, an offset distance of incident light in a direction perpendicular to an optical axis can be changed, so that a position of an emergent point of the incident light on the lens can be changed, and a propagation path of the light in the second lens group 300 can be adjusted. A thickness of the lens in the second lens group 300 may be specifically designed based on performance of the second lens module 3000. This is not limited in the present disclosure.

For example, the second lens group 300 includes the fourth lens 310, the fifth lens 320, the sixth lens 330, the seventh lens 340, and the eighth lens 350. Thicknesses of the fourth lens 310, the fifth lens 320, the sixth lens 330, the seventh lens 340, and the eighth lens 350 may be respectively denoted as h4, h5, h6, h7, and h8.

For example, the thickness h4 of the fourth lens 310 may satisfy 0.1 mm≤h433.0 mm. For example, h4 may be 0.2 mm, 0.4 mm, 0.6 mm, 1.0 mm, 1.5 mm, or 2.5 mm.

For example, the thickness h5 of the fifth lens 320 may satisfy 0.3 mm≤h533.0 mm. For example, h5 may be 0.4 mm, 0.8 mm, 1.0 mm, 1.2 mm, 1.5 mm, or 2.5 mm.

For example, the thickness h6 of the sixth lens 330 may satisfy 0.3 mm≤h6≤3.0 mm. For example, h6 may be 0.4 mm, 0.8 mm, 1.0 mm, 1.2 mm, 1.5 mm, or 2.5 mm.

For example, the thickness h7 of the seventh lens 340 may satisfy 0.3 mm≤h7≤3.0 mm. For example, h7 may be 0.4 mm, 0.8 mm, 1.0 mm, 1.5 mm, 2.0 mm, or 2.5 mm.

For example, the thickness h8 of the eighth lens 350 may satisfy 0.1 mm≤h835.0 mm. For example, h8 may be 0.5 mm, 1.0 mm, 1.5 mm, 2.0 mm, 2.5 mm, or 3.5 mm.

For a lens group including a plurality of lenses, a divergence or convergence capability of the entire lens group on incident light is not only related to an attribute (for example, a surface shape and a curvature radius of a lens) of each lens in the lens group, but also related to an arrangement manner of the plurality of lenses in the lens group. Specifically, for a form in which the plurality of lenses in the lens group are arranged along an optical axis, the divergence or convergence capability of the entire lens group on incident light is related to a distance between two adjacent lenses. By adjusting a spacing between two adjacent lenses, an overall focal length of the lens group can be adjusted to some extent. In addition, by adjusting a distance between lenses on two sides of the lens group, a propagation path of incident light in the lens group can also be affected to some extent, and a position of an emergent point after the incident light passes through the lens group is affected.

For example, the second lens group 300 includes the fourth lens 310, the fifth lens 320, the sixth lens 330, the seventh lens 340, and the eighth lens 350. Distances between two adjacent lenses in the fourth lens 310, the fifth lens 320, the sixth lens 330, the seventh lens 340, and the eighth lens 350 may be respectively denoted as D4, D5, D6, and D7.

For example, the distance D4 between the fourth lens 310 and the fifth lens 320 may satisfy: 0.01 mm≤D4≤3.0 mm. For example, D4 may be 0.03 mm, 0.10 mm, 0.50 mm, 1.00 mm, 1.50 mm, or 2.50 mm.

For example, the distance D5 between the fifth lens 320 and the sixth lens 330 may satisfy 0.2 mm≤D5≤5.0 mm. For example, D5 may be 0.3 mm, 0.8 mm, 1.0 mm, 2.0 mm, 3.0 mm, or 4.0 mm.

For example, the distance D6 between the sixth lens 330 and the seventh lens 340 may satisfy 0.2 mm≤D6≤3.0 mm. For example, D6 may be 0.3 mm, 0.9 mm, 1.5 mm, or 2.0 mm.

For example, the distance D7 between the seventh lens 340 and the eighth lens 350 may satisfy 0.2 mm≤D7≤10.0 mm. For example, D7 may be 0.3 mm, 0.5 mm, 2.0 mm, 4.0 mm, 6.0 mm, or 8.0 mm.

Changing a material of a lens can change a refractive index of the lens for light, and therefore, a refraction angle of incident light in the lens is different. Therefore, changing the material of the lens can also adjust a propagation path of the incident light in the lens to some extent. A material or a refractive index of the lens in the second lens group 300 may be specifically designed based on performance of the second lens group 300. This is not limited in the present disclosure.

In some examples, the lens in the second lens group 300 may be made of plastic or glass, for example, polymethyl methacrylate, polycarbonate, or a cyclic olefin polymer.

Factors such as a propagation path of incident light in a lens can be adjusted by selecting lens materials with different refractive indexes and Abbe numbers, thereby affecting an imaging effect of the lens module.

In some examples, a refractive index of one or more lenses included in the first lens group 100 is n2, and n2 satisfies 1.3000≤n2≤1.70000. For example, n2 may be 1.35000, 1.40000, 1.50000, 1.60000, or 1.65000.

In some examples, an Abbe number of one or more lenses included in the first lens group 100 is V2, and V2 satisfies 15.00≤V2≤70.00. For example, V2 may be 20.00, 25.00, 40.00, 50.00, 55.00, or 60.00.

By adjusting factors such as a quantity of lenses, a type of a lens, and a size of a lens in each of the first lens group 100 and the second lens group 300, a spacing between adjacent lenses in the lens group, and an arrangement manner of the first lens group 100, the first reflection element 200, the second lens group 300, and the photosensitive element 400, a lens module that has specific image stabilization performance and has both a long-focal-length photographing capability and a macro photographing capability can be implemented.

Using the second lens module 3000 shown in FIG. 3 as an example, G1 represents a focal length of the first lens group 100, and G2 represents a focal length of the second lens group 300. F #(1) represents an aperture size of the lens module in the first photographing state, and F #(2) represents an aperture size of the lens module in the second photographing state. EFL(1) represents an effective focal length of the lens module in the first photographing state, and EFL(2) represents an effective focal length of the lens module in the second photographing state.

H_{0.5} represents a half length of a diagonal of the photosensitive element 400. ΔL represents a moving distance of the second lens group 300 along the second optical axis O₂O₂ when the second lens module 3000 switches from the first photographing state to the second photographing state, that is, an auto focus stroke (auto focus stroke) of the lens module. S1 represents a distance from a farthest point on a lens on a side that is of the first lens group 100 and that is away from the first reflection element 200 to an edge of a side that is of the first reflection element 200 and that is away from the first lens group 100. S2 represents a distance (or referred to as an image stabilization stroke) by which the first lens group 100 moves in a direction perpendicular to the first optical axis O₁O₁.

In some examples, a value of F #(1) satisfies 2.00≤F #(1)≤3.50. For example, F #(1) may be 2.02, 2.55, 2.97, 3.20, or 3.32.

In some examples, a value of F #(2) satisfies 2.00≤F #(2)≤3.50. For example, F #(1) may be 2.03, 2.51, 2.92, 3.12, or 3.19.

In some examples, there is a correspondence between the value of F #(1) and the value of F #(2). For example, the values of F #(1) and F #(2) may be respectively (3.20, 3.12), (2.97, 2.92), (2.07, 2.03), or (3.32, 3.19).

In some examples, a value of EFL(1) satisfies 15≤EFL(1)≤30. For example, EFL(1) may be 19.00, 25.00, or 29.00.

In some examples, a value of EFL(2) satisfies: 12≤EFL(2)≤30. For example, EFL(2) may be 14.00, 20.00, 25.00, or 29.00.

In some examples, there is a correspondence between the value of EFL(1) and the value of EFL(2). For example, the values of EFL(1) and EFL(2) may be respectively (19.00, 14.48), (29.50, 28.54), or (29.49, 22.20).

In some examples, a magnification rate of the lens module in the second photographing state is β, and 0.01≤β≤0.5. For example, β may be 0.03, 0.1, or 0.3.

In some examples, an image stabilization angle in the image stabilization feature of the lens module is γ, and 0.5°≤γ≤3.0°. For example, γ may be 0.8°, 1.0°, or 2.0°.

In some examples, a value of the half length H_{0.5} of the diagonal of the photosensitive element 400 may satisfy: 3.00 mm≤H_{0.5}≤6.00 mm. For example, H_{0.5} may be 3.70 mm, 4.00 mm, 4.50 mm, 5.00 mm, or 5.50 mm.

In some examples, in the second photographing state, an object distance v(2) of the lens module satisfies 60 mm≤v(2)≤1000 mm. For example, v(2) may be 65.00 mm, 90.00 mm, 100.00 mm, 400.00 mm, 600.00 mm, or 800.00 mm.

In some examples, a value of the auto focus stroke (auto focus stroke) ΔL of the lens module satisfies: 1.00 mm≤ΔL≤3.00 mm. For example, ΔL may be 1.40 mm, 1.80 mm, 2.00 mm, 2.40 mm, 2.60 mm, or 2.80 mm.

In some examples, a value of the total track length S1 of the lens module satisfies: 20.00 mm≤S1≤30.00 mm. For example, S1 may be 22.00 mm, 24.00 mm, 26.00 mm, or 28.00 mm.

In some examples, a value of the image stabilization stroke S2 of the lens module satisfies: 0.20 mm≤S1≤0.40 mm. For example, S1 may be 0.22 mm, 0.24 mm, 0.28 mm, 0.30 mm, or 0.35 mm.

In some examples, a value of the focal length G1 of the first lens group 100 satisfies: 20.00 mm≤G1≤40.00 mm. For example, G1 may be 24.00 mm, 28.00 mm, 32.00 mm, 36.00 mm, or 38.00 mm.

In some examples, the focal length G1 of the first lens group 100 and S2 may satisfy:

$$\frac{G 1}{S 2} \geq 50.$$

For example, G1 may be 60×S2, 80×S2, 100×S2, or 120×S2.

In some examples, a maximum stroke by which the second lens group 300 moves in the first direction 2001 is ΔL, a total track length of the first lens module 2000 is S1, and S1 and ΔL may satisfy:

$$0.01 \leq \frac{Δ L}{S 1} \leq 0.4 .$$

For example, ΔL may be 0.05×S1, 0.1×S1, 0.2×S1, or 0.3×S1.

In some examples, the parameters of the lens module may further satisfy the following relationship:

$$0.1 \leq \frac{{H}_{0.5}}{E F L} \leq 0.5 and 0. 1 \leq \frac{{H}_{0.5}}{S 1} \leq 0.5 .$$

f1 and f2 respectively represent a focal length of a lens that is in the first lens group 100 and that is away from the first reflection element 200 and a focal length of a lens that is in the first lens group 100 and that is close to the first reflection element 200, and f3 to f7 respectively represent focal lengths of five lenses that are in the second lens group 300 and that are from a side close to the first reflection element 200 to a side away from the first reflection element 200.

In some examples, a value of f1 may satisfy: 10.00 mm≤f1≤25.00 mm. For example, f1 may be 12.47 mm, 16.40 mm, 19.68 mm, or 20.60 mm.

In some examples, a value of f2 may satisfy: −80.00 mm≤f2≤−20.00 mm. For example, f2 may be −78.68 mm, −38.97 mm, −31.01 mm, or −22.31 mm.

In some examples, a value of f3 may satisfy: −100.00 mm≤f3≤30.00 mm. For example, f3 may be −82.70 mm, −60.00 mm, 14.62 mm, 18.02 mm, or 23.16 mm.

In some examples, a value of f4 may satisfy: −60.00 mm≤f4≤−10.00 mm. For example, f4 may be −53.45 mm, −32.73 mm, −26.27 mm, −15.11 mm, or −12.48 mm.

In some examples, a value of f5 may satisfy: −5.00 mm≤f5≤15.00 mm. For example, f5 may be −11.15 mm, −8.56 mm, 7.63 mm, 8.20 mm, or 8.91 mm.

In some examples, a value of f6 may satisfy: −150 mm≤f6≤80.00 mm. For example, f6 may be −144.06 mm, −67.15 mm, −26.08 mm, 5.05 mm, or 68.5 mm.

In some examples, a value of f7 may satisfy: −20.00 mm≤f7≤25.00 mm. For example, f7 may be −24.67 mm, −15.06 mm, 13.84 mm, 15.66 mm, or 20.18 mm.

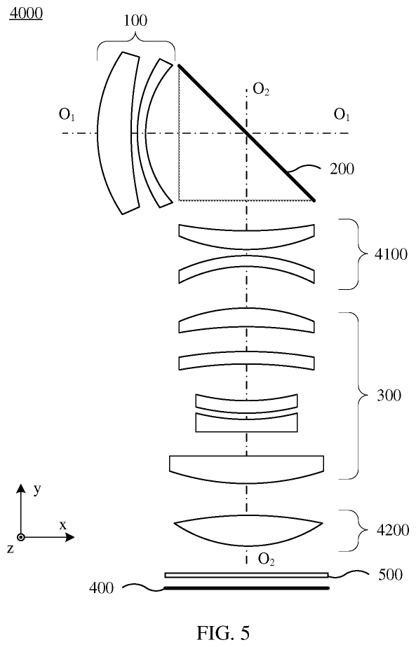

FIG. 5 is a diagram of a structure of a third lens module 4000 according to an embodiment of the present disclosure. The third lens module 4000 may include the first lens group 100, the first reflection element 200, the second lens group 300, and the photosensitive element 400 that are in the foregoing second lens module 3000. The third lens module 4000 further includes at least one extended lens group. The extended lens group may be configured to adjust light incident to the second lens group 300, or the third lens group may be configured to adjust light emergent from the second lens group 300.

In some examples, the third lens module 4000 may include a third lens group 4100. The third lens group 4100 is located between the first reflection element 200 and the second lens group 300. After passing through the third lens group 4100, light emergent from the first reflection element 200 may be incident to the second lens group 300, and finally be projected onto the photosensitive element 400.

In some examples, the third lens module 4000 may include a third lens group 4100. The third lens group 4100 is located between the second lens group 300 and the photosensitive element 400, and light emergent from the second lens group 300 is incident to the photosensitive element 400 after passing through the third lens group 4100.

In some examples, the third lens module 4000 may include two extended lens groups, or the third lens module 4000 may include a third lens group 4100 and a fourth lens group 4200. The third lens group 4100 is located between the first reflection element 200 and the second lens group 300, and the fourth lens group 4200 is located between the second lens group 300 and the photosensitive element 400. Light emergent from the first reflection element 200 is incident to the second lens group 300 after passing through the third lens group 4100, and is incident to the fourth lens group 4200 after passing through the second lens group 300. Light emergent from the fourth lens group 4200 may be incident to the photosensitive element 400.

The extended lens groups in the foregoing different cases may include one or more lenses. For example, as shown in FIG. 5, the third lens group 4100 may include two lenses, and the fourth lens group 4200 may include one lens.

A surface of the lens included in the extended lens group may be a spherical surface or an aspheric surface. For example, as shown in FIG. 5, surfaces of the two lenses in the third lens group 4100 are aspheric surfaces, a surface on a side that is of the lens in the fourth lens group 4200 and that is away from the photosensitive element 400 is an aspheric surface, and a surface on a side that is of the lens in the fourth lens group 4200 and that is close to the photosensitive element 400 is a spherical surface.

The extended lens group may have a positive focal power or a negative focal power. When the extended lens group includes a plurality of lenses, different lenses may have positive focal powers or negative focal powers. This is not limited in the present disclosure. Specifically, positive focal powers and negative focal powers of different lenses may be determined based on design performance of the extended lens group. For a corresponding description, refer to the foregoing description of a design of a positive focal power or a negative focal power of each lens when the first lens group 100 or the second lens group 300 includes a plurality of lenses. For brevity, details are not described herein again.

When the extended lens group includes a plurality of lenses, factors such as selection of a surface shape of each lens, setting of a surface curvature radius, a thickness of a lens, a spacing between two adjacent lenses, and a material for preparing a lens affect a divergence or convergence function of the extended lens group on incident light, thereby affecting propagation of the incident light in the third lens module 4000, and affecting imaging quality of the lens module. A method for setting these control factors is similar to the foregoing related descriptions of the first lens group 100 and the second lens group 300. For details, refer to the foregoing descriptions. For brevity, details are not described herein again.

In some examples, a position of the extended lens group in the third lens module 4000 is relatively fixed, or the position of the extended lens group and the position of the photosensitive element 400 are fixed relative to each other. In a process in which the second lens group 300 in the third lens module 4000 moves along the second optical axis O₂O₂, a distance between the second lens group 300 and the extended lens group changes, and a position of an incident point of light on the second lens group 300 and/or a position of an incident point of light on the photosensitive element 400 correspondingly change/changes. Therefore, moving of the second lens group 300 along the second optical axis O₂O₂ can implement a zoom function of the third lens module 4000.

The extended lens group may adjust a propagation path of light incident to the second lens group 300, or the extended lens group may adjust a propagation path of light emergent from the second lens group 300, or a plurality of extended lens groups may be disposed at the same time to adjust both a propagation path of light incident to the second lens group 300 and a propagation path of light emergent from the second lens group 300. Disposing of the extended lens group increases an adjustable dimension of a propagation path of light incident to the third lens module 4000, so that imaging of the third lens module 4000 on the photosensitive element 400 is clearer, and imaging quality is improved.

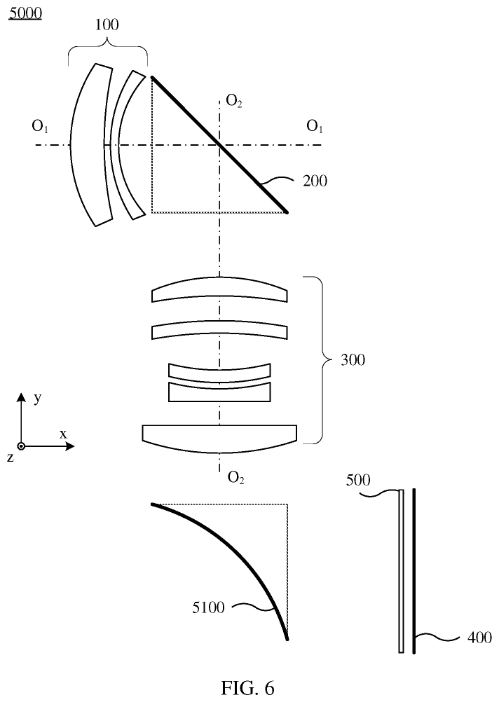

FIG. 6 is a diagram of a structure of a fourth lens module 5000 according to an embodiment of the present disclosure. The fourth lens module 5000 may include the first lens group 100, the first reflection element 200, the second lens group 300, and the photosensitive element 400 that are in the second lens module 3000. The fourth lens module 5000 may further include a second reflection element. The second reflection element may be configured to adjust a propagation path of light emergent from the second lens group 300.

In some examples, as shown in FIG. 6, the second reflection element 5100 in the fourth lens module 5000 is located between the second lens group 300 and the photosensitive element 400, or in other words, light emergent from the second lens group 300 may be incident to the photosensitive element 400 after being reflected by the second reflection element 5100. The second reflection element 5100 may include a second reflection surface, where the second reflection surface may be inclined to the second optical axis O₂O₂, a plane in which the photosensitive element 400 is located is inclined to the second optical axis O₂O₂, and light emergent from the second lens group 300 is incident to the photosensitive element 400 after being reflected by the second reflection surface.

For example, the plane in which the photosensitive element 400 is located may be parallel to the second optical axis O₂O₂. In other words, a normal line of the plane in which the photosensitive element 400 is located is parallel to the second optical axis O₂O₂.

In some examples, the second reflection element 5100 may be one or more of a planar reflector, a right-angle prism reflector, an off-axis parabolic reflector, a hollow ridge prism reflector, or the like. For example, the second reflection element 5100 may be a right-angle prism reflection element. For example, the second reflection element 5100 in FIG. 6 is an aspheric reflector.

The second reflection element 5100 may be disposed to adjust a propagation path of light incident to the photosensitive element 400, for example, adjust light originally propagated along the second optical axis O₂O₂ to propagate in a direction perpendicular to the second optical axis O₂O₂. The second reflection element 5100 is disposed, so that a position of the photosensitive element 400 in the fourth lens module 5000 is more flexible, thereby improving utilization of space occupied by the fourth lens module 5000, and to some extent, helping reduce space occupied by the lens module 5000 in the direction of the second optical axis O₂O₂. In addition, the second reflection element 5100 can also increase a propagation optical distance of light before the light is incident to the photosensitive element 400, which helps increase a quantity of light that can be captured by the photosensitive element 400 to some extent, and helps improve imaging quality.

Similar to the first reflection element 200 included in the second lens module 3000, a shape and a size of the second reflection element 5100, a distance between the second reflection element 5100 and the second lens group 300, and a distance between the second reflection element 5100 and the photosensitive element 400 may all affect a propagation path of incident light in the fourth lens module 5000, thereby affecting imaging quality of the lens module.

For example, the second reflection element 5100 is a diameter prism reflection element. A thickness of the second reflection element 5100 may be denoted as hr2, and hr2 may satisfy: 1.00 mm≤hr2≤10.0 mm. For example, hr2 may be 3.00 mm, 5.00 mm, 6.00 mm, 6.50 mm, 7.00 mm, 8.00 mm, or 9.00 mm.

For example, the second reflection element 5100 is a diameter prism reflection element. A spacing between the second reflection element 5100 and the second lens group 300 and a spacing between the second reflection element 5100 and the photosensitive element 400 may be adjusted based on a performance requirement of the lens module and with reference to a layout of each element.

In some examples, the fourth lens module 5000 may further include the extended lens group included in the third lens module 4000. The extended lens group may be configured to adjust a propagation path of incident light incident to the second lens group 300 and/or a propagation path of emergent light emergent from the second lens group 300.

For example, the extended lens group may be disposed between the first reflection element 200 and the second lens group 300, and is configured to adjust a propagation path of incident light incident to the second lens group 300.

Similarly, for example, the extended lens group may be disposed between the second lens group 300 and the second reflection element 5100, and is configured to adjust a propagation path of emergent light emergent from the second lens group 300.

Still for example, there may be two extended lens groups, which are respectively disposed between the first reflection element 200 and the second lens group 300 and between the second lens group 300 and the second reflection element 5100, so that the extended lens groups adjust propagation paths of both incident light and emergent light of the second lens group 300.

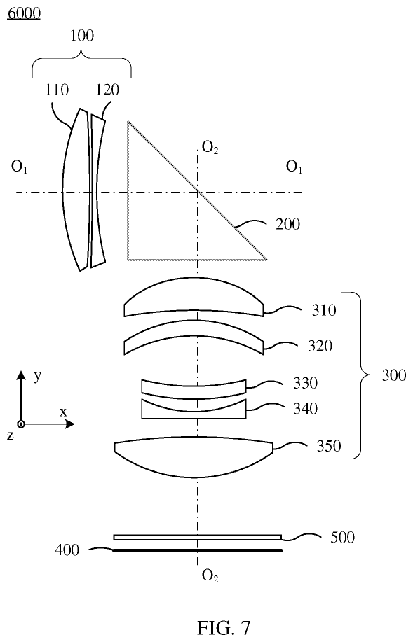

FIG. 7 shows a fifth lens module 6000 according to an embodiment of the present disclosure. The fifth lens module 6000 includes the first lens group 100, the first reflection element 200, the second lens group 300, the infrared cut-off filter 500, and the photosensitive element 400 that are in the first lens module 2000.

The first lens group 100 has a positive focal power, the first lens group 100 includes a first lens 110 and a second lens 120, the first lens 110 has a positive focal power, and the second lens 120 has a negative focal power.

In some examples, a thickness of the first lens 110 is about 2.18 mm, a thickness of the second lens 120 is about 0.46 mm, and a spacing between the first lens 110 and the second lens 120 is about 0.03 mm.

In some examples, an Abbe number of the first lens 110 is about 74.54, and a refractive index thereof is about 1.5021. An Abbe number of the second lens 120 is about 67.05, and a refractive index thereof is about 1.1922.

In some examples, the first lens 110 includes a first mirror surface and a second mirror surface that are disposed opposite to each other, the second lens 120 includes a third mirror surface and a fourth mirror surface that are disposed opposite to each other, the first mirror surface, the second mirror surface, the third mirror surface, and the fourth mirror surface are all aspheric surfaces, and a shape of the aspheric surface may be determined according to the foregoing formula (1).

For example, as shown in FIG. 7, the first mirror surface protrudes in a negative direction of an x-axis, a curvature radius of the first mirror surface is about 22.05 mm, the second mirror surface protrudes in a positive direction of the x-axis, and a curvature radius of the second mirror surface is about 43.69 mm.

The third mirror surface protrudes in the positive direction of the x-axis, a curvature radius of the third mirror surface is about 95.39 mm, the fourth mirror surface protrudes in the negative direction of the x-axis, and a curvature radius of the fourth mirror surface is about 32.35 mm.

The first lens 110 and the second lens 120 are fixed relative to each other, and the first lens group 100 may move in a plane perpendicular to an optical axis of the first lens group 100, to implement an image stabilization function of the lens module.

The second lens group 300 includes a fourth lens 310, a fifth lens 320, a sixth lens 330, a seventh lens 340, and an eighth lens 350. The fourth lens 310 has a positive focal power, the fifth lens 320 has a negative focal power, the sixth lens 330 has a negative focal power, the seventh lens 340 has a negative focal power, and the eighth lens has a positive focal power.

The second lens group 300 has a positive focal power. Positions of the fourth lens 310, the fifth lens 320, the sixth lens 330, the seventh lens 340, and the eighth lens 350 included in the second lens group 300 are fixed relative to each other. The second lens group 300 may move close to or away from the photosensitive element 400 in a direction of an optical axis of the second lens group 300. In a macro photographing mode, the second lens group 300 may move away from the photosensitive element 400 along the optical axis. In the long-focal-length photographing mode, the second lens group 300 may move close to the photosensitive element 400 along the optical axis.

In some examples, a thickness of the fourth lens 310 is about 2.37 mm, a thickness of the fifth lens 320, a thickness of the sixth lens 330, and a thickness of the seventh lens 340 are all about 0.40 mm, and a thickness of the eighth lens 350 is about 2.48 mm. A spacing between the fourth lens 310 and the fifth lens 320 is about 1.43 mm, a spacing between the fifth lens 320 and the sixth lens 330 is about 3.91 mm, a spacing between the sixth lens 330 and the seventh lens 340 is about 0.89 mm, and a spacing between the seventh lens 340 and the eighth lens 350 is about 2.96 mm.

In some examples, an Abbe number of the fourth lens 310 is about 53.45, and a refractive index thereof is about 1.5604. An Abbe number of the fifth lens 320 is about 53.45, and a refractive index thereof is about 1.5604. An Abbe number of the sixth lens 330 is about 53.45, and a refractive index thereof is about 1.5604. An Abbe number of the seventh lens 340 is about 67.05, and a refractive index thereof is about 1.1922. An Abbe number of the eighth lens 350 is about 57.47, and a refractive index thereof is about 1.3375.

In some examples, the fourth lens 310 includes a fifth mirror surface and a sixth mirror surface that are disposed opposite to each other, the fifth lens 320 includes a seventh mirror surface and an eighth mirror surface that are disposed opposite to each other, the sixth lens 330 includes a ninth mirror surface and a tenth mirror surface that are disposed opposite to each other, the seventh lens 340 includes an eleventh mirror surface and a twelfth mirror surface that are disposed opposite to each other, the eighth lens 350 includes a thirteenth mirror surface and a fourteenth mirror surface that are disposed opposite to each other, all the mirror surfaces are aspheric surfaces, and a shape of the aspheric surface may be determined according to the foregoing formula (1).

For example, as shown in FIG. 7, the fifth mirror surface protrudes in a positive direction of a y-axis, a curvature radius thereof is about 7.44 mm, the sixth mirror surface protrudes in the positive direction of the y-axis, and a curvature radius thereof is about 11.86 mm.

The seventh mirror surface protrudes in the positive direction of the y-axis, a curvature radius thereof is about 6.82 mm, the eighth mirror surface protrudes in the positive direction of the y-axis, and a curvature radius thereof is about 8.00 mm.

The ninth mirror surface protrudes in a negative direction of the y-axis, a curvature radius thereof is about 14.72 mm, the tenth mirror surface protrudes in the negative direction of the y-axis, and a curvature radius thereof is about 10.11 mm.

The eleventh mirror surface protrudes in the negative direction of the y-axis, a curvature radius thereof is about 7.69 mm, the twelfth mirror surface protrudes in the negative direction of the y-axis, and a curvature radius thereof is about 22.92 mm.

The thirteenth mirror surface protrudes in the positive direction of the y-axis, a curvature radius thereof is about 9.97 mm, the fourteenth mirror surface protrudes in the negative direction of the y-axis, and a curvature radius thereof is about 5.94 mm.

Light from a photographed object is incident to the first reflection element 200 after successively passing through the first lens 110 and the second lens 120 of the first lens group 100, is incident to the second lens group 300 after being folded by 90°, successively passes through the fourth lens 310, the fifth lens 320, the sixth lens 330, the seventh lens 340, and the eighth lens 350, and then is incident to the photosensitive element 400 after passing through the infrared cut-off filter 500.

In some examples, a distance between the first lens group 100 and the first reflection element 200 is about 0.63 mm, a distance between the first reflection element 200 and the second lens group 300 is about 2.57 mm, and a distance between the second lens group 300 and the photosensitive element 400 is about 1.04 mm.

In some examples, surfaces of a plurality of lenses included in the first lens group 100 and the second lens group 300 may be aspheric surfaces, and a specific shape of the surface of the lens may be determined according to the foregoing formula (1). For example, aspheric coefficients of the plurality of lenses are shown in the following table.

TABLE 1

| | s2 | s3 | s4 | s5 | s8 | s9 | s10 |
|---|---|---|---|---|---|---|---|
| k | 0 | 0 | 0 | 0 | 0 | 0 | 0 |
| A4 | −0.00004 | −0.000618 | −0.000618 | 0.0023692 | 0.0002001 | 0.0011891 | 0.0093907 |
| A6 | −0.000005 | 0.0001029 | 0.0001029 | −0.00012 | −0.000026 | −0.000061 | −0.001772 |
| A8 | 3.60E−07 | −0.000011 | −0.000011 | 0.000005 | 0.000004 | −0.00004 | 0.0001915 |
| A10 | −6.25E−09 | 1.00E−06 | 1.00E−06 | −1.10E−07 | −1.00E−06 | 1.00E−05 | −1.40E−05 |
| A12 | −7.66E−10 | −2.66E−08 | −2.66E−08 | 1.59E−09 | 1.39E−07 | −6.21E−08 | 1.00E−06 |
| A14 | 5.29E−11 | 6.87E−10 | 6.87E−10 | −1.26E−11 | −9.45E−09 | 1.93E−09 | −3.03E−08 |
| A16 | −1.39E−12 | −1.11E−11 | −1.11E−11 | 4.36E−14 | 3.23E−10 | −3.09E−11 | 4.19E−10 |
| A18 | 1.63E−14 | 1.00E−13 | 1.00E−13 | 0.00E+00 | −5.04E−12 | 2.12E−13 | 7.70E−12 |
| A20 | −7.00E−17 | −3.89E−16 | −3.89E−16 | 0.00E+00 | 2.30E−14 | 0.00E+00 | −2.14E−13 |
| A22 | 0 | 0 | 0 | 0 | 0 | 0 | 0 |
| A24 | 0 | 0 | 0 | 0 | 0 | 0 | 0 |
| A26 | 0 | 0 | 0 | 0 | 0 | 0 | 0 |
| A28 | 0 | 0 | 0 | 0 | 0 | 0 | 0 |
| A30 | 0 | 0 | 0 | 0 | 0 | 0 | 0 |
| | s11 | s12 | s13 | s14 | s15 | s16 | s17 |
| k | 0 | 0 | 0 | 0 | 0 | 0 | 0 |
| A4 | 0.0083188 | −0.008357 | −0.009748 | −0.001415 | 0.0057281 | 0.0022156 | 0.000063 |
| A6 | −0.001867 | −0.001694 | −0.00367 | −0.002548 | −0.000066 | −0.000027 | 0.000034 |
| A8 | 0.0001833 | 0.0005817 | 0.0002479 | 0.000998 | 0.007389 | 1.62E−07 | 4.00E−06 |
| A10 | −1.00E−05 | −2.40E−05 | −4.00E−05 | 8.00E−06 | 5.00E−05 | −5.42E−10 | 8.11E−08 |
| A12 | 3.32E−07 | −1.00E−05 | 1.70E−05 | 7.20E−05 | 1.05E−04 | 1.03E−12 | 8.40E−10 |
| A14 | 6.80E−09 | 2.00E−06 | −2.00E−06 | −1.20E−05 | −3.10E−05 | 0.00E+00 | −1.14E−12 |
| A16 | 8.29E−11 | −1.12E−07 | 1.36E−07 | 1.00E−06 | 4.00E−06 | 0.00E+00 | 0.00E+00 |
| A18 | −4.92E−13 | 2.77E−09 | −3.05E−09 | −2.40E−08 | −2.31E−07 | 0.00E+00 | 0.00E+00 |
| A20 | 0.00E+00 | 0.00E+00 | 0.00E+00 | 2.16E−10 | 4.95E−09 | 0.00E+00 | 0.00E+00 |
| A22 | 0 | 0 | 0 | 0.00E+00 | 3.21E−11 | 0.00E+00 | 0 |
| A24 | 0 | 0 | 0 | 0 | 0 | 0 | 0 |
| A26 | 0 | 0 | 0 | 0 | 0 | 0 | 0 |
| A28 | 0 | 0 | 0 | 0 | 0 | 0 | 0 |
| A30 | 0 | 0 | 0 | 0 | 0 | 0 | 0 |

Optical parameters of the fifth lens module 6000 shown in the following Table 2 may be obtained by setting a lens parameter, a lens group arrangement, and the like in the lens module. A focal length of the first lens group 100 is 39.98 mm, an image stabilization stroke thereof is 0.35 mm, and a ratio of the two is about 114. An adjustable distance ΔL of the second lens group 300 along the optical axis is 1.77 mm, a total track length of the lens module is 26.00 mm, and a ratio of the two is about 0.07. In the macro paragraphing mode of the lens module, a magnification rate may be 0.1 to 0.5, and an image stabilization angle may be 0.5° to 3.0°.

TABLE 2

| | | | | | Magnification rate | |
|---|---|---|---|---|---|---|
| | | | | | in macro | |
| F#(1) | F#(2) | EFL(1)/mm | EFL(2)/mm | H_{0.5}/mm | photographing | |
| 2.07 | 2.03 | 29.49 | 28.90 | 3.50 | 0.03 | |
| Object distance | | | | | | |
| in macro | | | | | | |
| photographing/mm | Δ L/mm | S1/mm | S2/mm | f1/mm | f2/mm | |
| 1000 | 1.77 | 26.00 | 0.35 | 20.10 | −38.97 | |
| f3/mm | f4/mm | f5/mm | f6/mm | f7/mm | G1/mm | G2/mm |
| 14.62 | −26.27 | −11.15 | −26.80 | 15.66 | 39.98 | 63.87 |

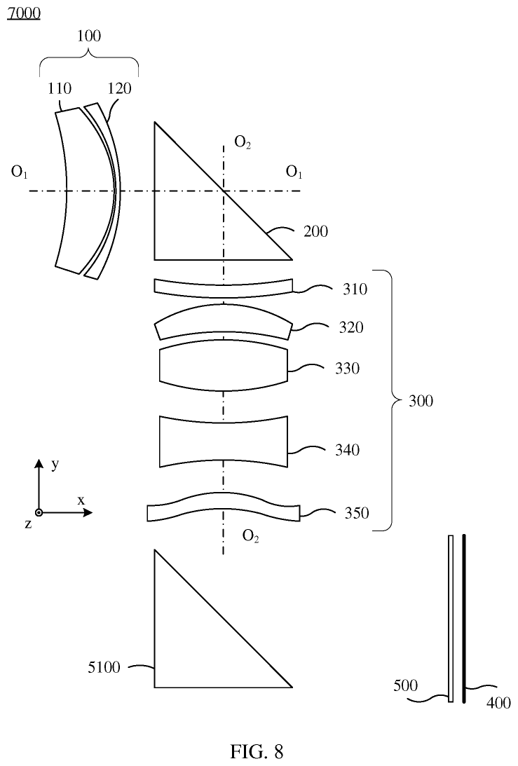

FIG. 8 shows a sixth lens module 7000 according to an embodiment of the present disclosure. The sixth lens module 7000 includes the first lens group 100, the first reflection element 200, the second lens group 300, the second reflection element 5100, the infrared cut-off filter 500, and the photosensitive element 400 that are in the first lens module 2000.

The first lens group 100 includes a first lens 110 and a second lens 120, the first lens 110 has a positive focal power, and the second lens 120 has a negative focal power.

In some examples, a thickness of the first lens 110 is about 2.87 mm, a thickness of the second lens 120 is about 0.29 mm, and a spacing between the first lens 110 and the second lens 120 is about 0.03 mm.

In some examples, an Abbe number of the first lens 110 is about 75.03, and a refractive index thereof is about 1.4999. An Abbe number of the second lens 120 is about 67.05, and a refractive index thereof is about 1.1922.

In some examples, the first lens 110 includes a first mirror surface and a second mirror surface that are disposed opposite to each other, the second lens 120 includes a third mirror surface and a fourth mirror surface that are disposed opposite to each other, the first mirror surface, the second mirror surface, the third mirror surface, and the fourth mirror surface are all aspheric surfaces, and a shape of the aspheric surface may be determined according to the foregoing formula (1).

For example, as shown in FIG. 8, the first mirror surface protrudes in a positive direction of an x-axis, a curvature radius of the first mirror surface is about 22.29 mm, the second mirror surface protrudes in the positive direction of the x-axis, and a curvature radius of the second mirror surface is about 9.36 mm.

The third mirror surface protrudes in the positive direction of the x-axis, a curvature radius of the third mirror surface is about 10.33 mm, the fourth mirror surface protrudes in the positive direction of the x-axis, and a curvature radius of the fourth mirror surface is about 11.24 mm.

The second lens group 300 includes a fourth lens 310, a fifth lens 320, a sixth lens 330, a seventh lens 340, and an eighth lens 350. The fourth lens 310 has a negative focal power, the fifth lens 320 has a negative focal power, the sixth lens 330 has a positive focal power, the seventh lens 340 has a negative focal power, and the eighth lens has a negative focal power.

In some examples, a thickness of the fourth lens 310 is about 0.28 mm, a thickness of the fifth lens 320 is about 1.26 mm, a thickness of the sixth lens 330 is about 2.84 mm, a thickness of the seventh lens 340 is about 2.70 mm, and a thickness of the eighth lens 350 is about 0.69 mm. A spacing between the fourth lens 310 and the fifth lens 320 is about 0.03 mm, a spacing between the fifth lens 320 and the sixth lens 330 is about 0.60 mm, a spacing between the sixth lens 330 and the seventh lens 340 is about 0.67 mm, and a spacing between the seventh lens 340 and the eighth lens 350 is about 0.27 mm.

In some examples, an Abbe number of the fourth lens 310 is about 56.97, and a refractive index thereof is about 1.3538. An Abbe number of the fifth lens 320 is about 63.40, and a refractive index thereof is about 1.2263. An Abbe number of the sixth lens 330, an Abbe number of the seventh lens 340, and an Abbe number of the eighth lens 350 are all about 53.45, and refractive indexes thereof are all about 1.5604.

In some examples, the fourth lens 310 includes a fifth mirror surface and a sixth mirror surface that are disposed opposite to each other, the fifth lens 320 includes a seventh mirror surface and an eighth mirror surface that are disposed opposite to each other, the sixth lens 330 includes a ninth mirror surface and a tenth mirror surface that are disposed opposite to each other, the seventh lens 340 includes an eleventh mirror surface and a twelfth mirror surface that are disposed opposite to each other, the eighth lens 350 includes a thirteenth mirror surface and a fourteenth mirror surface that are disposed opposite to each other, all the mirror surfaces are aspheric surfaces, and a shape of the aspheric surface may be determined according to the foregoing formula (1).

For example, as shown in FIG. 8, the fifth mirror surface protrudes in a negative direction of a y-axis, a curvature radius thereof is about 18.93 mm, the sixth mirror surface protrudes in the negative direction of the y-axis, and a curvature radius thereof is about 23.62 mm.

The seventh mirror surface protrudes in a positive direction of the y-axis, a curvature radius thereof is about 7.19 mm, the eighth mirror surface protrudes in the positive direction of the y-axis, and a curvature radius thereof is about 5.05 mm.

The ninth mirror surface protrudes in the positive direction of the y-axis, a curvature radius thereof is about 8.12 mm, the tenth mirror surface protrudes in the negative direction of the y-axis, and a curvature radius thereof is about 10.80 mm.

The eleventh mirror surface protrudes in the negative direction of the y-axis, a curvature radius thereof is about 18.83 mm, the twelfth mirror surface protrudes in the positive direction of the y-axis, and a curvature radius thereof is about 22.04 mm.

The thirteenth mirror surface protrudes in the positive direction of the y-axis, a curvature radius thereof is about 12.37 mm, the fourteenth mirror surface protrudes in the positive direction of the y-axis, and a curvature radius thereof is about 25.19 mm.

Light from a photographed object is incident to the first reflection element 200 after successively passing through the first lens 110 and the second lens 120 of the first lens group 100, is incident to the second lens group 300 after being folded by 90°, is incident to the second reflection element 5100 after successively passing through the fourth lens 310, the fifth lens 320, the sixth lens 330, the seventh lens 340, and the eighth lens 350, and is incident to the photosensitive element 400 after being folded by 90° and passing through the infrared cut-off filter 500.

In some examples, a distance between the first lens group 100 and the first reflection element 200 is about 0.41 mm, a distance between the first reflection element 200 and the second lens group 300 is about 3.01 mm, and a distance between the second lens group 300 and the photosensitive element 400 is about 0.95 mm.

In some examples, surfaces of a plurality of lenses included in the first lens group 100 and the second lens group 300 may be aspheric surfaces, and a specific shape of the surface of the lens may be determined according to the foregoing formula (1). For example, aspheric coefficients of the plurality of lenses are shown in the following table.

TABLE 3

| | s2 | s3 | s4 | s5 | s8 | s9 | s10 |
|---|---|---|---|---|---|---|---|
| k | 0 | 0 | 0 | 0 | 0 | 0 | 0 |
| A4 | 0.000067 | −0.00024511 | 0.00193157 | 0.00247784 | −0.0121706 | 0.00379114 | −0.00542776 |
| A6 | −0.000009 | 0.00002 | −0.000249311 | −0.000275866 | 0.00242156 | 0.00015616 | 0.00206306 |
| A8 | 1.00E−06 | −0.000001 | 0.000019 | 0.000019 | −0.000593142 | −0.000281171 | −0.000369816 |
| A10 | −6.03E−08 | 1.96E−08 | −1.00E−06 | −1.00E−06 | 0.000103469 | 0.000062 | 0.000037 |
| A12 | 1.62E−09 | 8.37E−12 | 3.53E−08 | 1.75E−08 | −0.000011 | −0.000007 | −0.000002 |
| A14 | −2.38E−11 | −8.46E−12 | −9.00E−10 | −2.44E−10 | 1.00E−06 | 3.90E−07 | 8.25E−08 |
| A16 | 1.86E−13 | 1.54E−13 | 1.49E−11 | 1.92E−12 | −2.36E−08 | −1.27E−08 | −1.76E−09 |
| A18 | 6.45E−16 | −9.69E−16 | −1.39E−13 | −6.60E−15 | 3.48E−10 | 1.84E−10 | 1.72E−11 |
| A20 | 0.00E+00 | −3.89E−16 | 5.31E−16 | 0.00E+00 | 0.00E+00 | 0.00E+00 | −2.14E−13 |
| A22 | 0 | 0 | 0 | 0 | 0 | 0 | 0 |
| A24 | 0 | 0 | 0 | 0 | 0 | 0 | 0 |
| A26 | 0 | 0 | 0 | 0 | 0 | 0 | 0 |
| A28 | 0 | 0 | 0 | 0 | 0 | 0 | 0 |
| A30 | 0 | 0 | 0 | 0 | 0 | 0 | 0 |
| | s11 | s12 | s13 | s14 | s15 | s16 | s17 |
| k | 0 | 0 | 0 | 0 | 0 | 0 | −1 |
| A4 | −0.0248503 | 0.000044 | 0.000339437 | 0.0204922 | 0.00793216 | −0.022741 | −0.0348705 |
| A6 | 0.00430107 | −0.00101387 | 0.00051341 | −0.00645433 | 0.00151797 | −0.00469951 | 0.00731267 |
| A8 | −0.000608428 | 0.000310082 | 0.000150425 | 0.00157612 | −0.000718627 | 0.00851621 | −0.00143584 |
| A10 | 0.000054 | −0.000059 | −0.00003 | −0.00027135 | 0.000168225 | −0.00471904 | 0.000212994 |
| A12 | −0.000003 | 0.000007 | 0.000004 | 0.000031 | −0.000025 | 0.00144538 | −0.000022 |
| A14 | 1.07E−07 | −1.00E−06 | −2.66E−07 | −2.00E−06 | 0.000002 | −2.71E−04 | 2.00E−06 |
| A16 | −7.05E−10 | 2.18E−08 | 1.01E−08 | 9.03E−08 | −1.42E−07 | 3.20E−05 | −7.36E−08 |
| A18 | −1.05E−10 | −3.91E−10 | −1.65E−10 | −1.74E−09 | 4.61E−09 | −2.00E−06 | 1.91E−09 |
| A20 | 0.00E+00 | 0.00E+00 | 0.00E+00 | 2.16E−10 | −5.68E−11 | 9.18E−08 | −2.09E−11 |
| A22 | 0 | 0 | 0 | 0.00E+00 | −2.10E−13 | −1.58E−09 | −1.68E−14 |
| A24 | 0 | 0 | 0 | 0 | 0 | 0 | 0 |
| A26 | 0 | 0 | 0 | 0 | 0 | 0 | 0 |
| A28 | 0 | 0 | 0 | 0 | 0 | 0 | 0 |
| A30 | 0 | 0 | 0 | 0 | 0 | 0 | 0 |

Optical parameters of the sixth lens module 7000 shown in the following Table 4 may be obtained by setting a lens parameter, a lens group arrangement, and the like in the lens module. A focal length of the first lens group 100 is 28.51 mm, an image stabilization stroke thereof is 0.30 mm, and a ratio of the two is about 95. An adjustable distance ΔL of the second lens group 300 along the optical axis is 2.60 mm, a total track length of the lens module is 28.98 mm, and a ratio of the two is about 0.09. In the macro paragraphing mode of the lens module, a magnification rate may be 0.1 to 0.5, and an image stabilization angle may be 0.5° to 3.0°.

TABLE 4

| | | | | | Magnification | |
|---|---|---|---|---|---|---|
| | | | | | rate in macro | |
| F#(1) | F#(2) | EFL(1)/mm | EFL(2)/mm | H_{0.5}/mm | photographing | |
| 2.02 | 2.04 | 19.00 | 14.48 | 5.42 | 0.30 | |
| Object distance | | | | | | |
| in macro | | | | | | |
| photographing/mm | Δ L/mm | S1/mm | S2/mm | f1/mm | f2/mm | |
| 61.30 | 2.60 | 28.98 | 0.30 | 20.60 | −78.68 | |
| f3/mm | f4/mm | f5/mm | f6/mm | f7/mm | G1/mm | G2/mm |
| −82.70 | −21.72 | 7.63 | −67.15 | −24.67 | 28.51 | 14.18 |

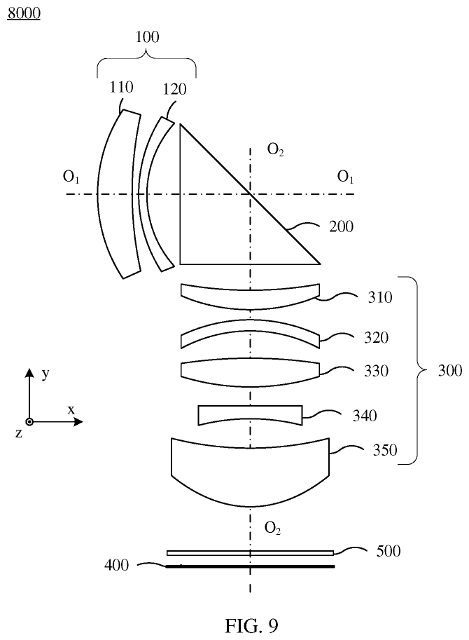

FIG. 9 shows a seventh lens module 8000 according to an embodiment of the present disclosure. The seventh lens module 8000 includes the first lens group 100, the first reflection element 200, the second lens group 300, the infrared cut-off filter 500, and the photosensitive element 400 that are in the first lens module 2000.

The first lens group 100 includes a first lens 110 and a second lens 120, the first lens 110 has a positive focal power, and the second lens 120 has a negative focal power.

In some examples, a thickness of the first lens 110 is about 1.68 mm, a thickness of the second lens 120 is about 0.26 mm, and a spacing between the first lens 110 and the second lens 120 is about 0.03 mm.

In some examples, an Abbe number of the first lens 110 is about 70.87, and a refractive index thereof is about 1.5201. An Abbe number of the second lens 120 is about 61.57, and a refractive index thereof is about 1.2521.

In some examples, the first lens 110 includes a first mirror surface and a second mirror surface that are disposed opposite to each other, the second lens 120 includes a third mirror surface and a fourth mirror surface that are disposed opposite to each other, the first mirror surface, the second mirror surface, the third mirror surface, and the fourth mirror surface are all aspheric surfaces, and a shape of the aspheric surface may be determined according to the foregoing formula (1).

For example, as shown in FIG. 9, the first mirror surface protrudes in a negative direction of an x-axis, a curvature radius of the first mirror surface is about 8.60 mm, the second mirror surface protrudes in the negative direction of the x-axis, and a curvature radius of the second mirror surface is about 391.94 mm.

The third mirror surface protrudes in the negative direction of the x-axis, a curvature radius of the third mirror surface is about 14.50 mm, the fourth mirror surface protrudes in the negative direction of the x-axis, and a curvature radius of the fourth mirror surface is about 6.86 mm.

The second lens group 300 includes a fourth lens 310, a fifth lens 320, a sixth lens 330, a seventh lens 340, and an eighth lens 350. The fourth lens 310 has a positive focal power, the fifth lens 320 has a negative focal power, the sixth lens 330 has a positive focal power, the seventh lens 340 has a negative focal power, and the eighth lens has a positive focal power.

In some examples, a thickness of the fourth lens 310 is about 0.30 mm, a thickness of the fifth lens 320 is about 0.28 mm, a thickness of the sixth lens 330 is about 0.97 mm, a thickness of the seventh lens 340 is about 0.52 mm, and a thickness of the eighth lens 350 is about 3.43 mm. A spacing between the fourth lens 310 and the fifth lens 320 is about 0.03 mm, a spacing between the fifth lens 320 and the sixth lens 330 is about 1.26 mm, a spacing between the sixth lens 330 and the seventh lens 340 is about 1.57 mm, and a spacing between the seventh lens 340 and the eighth lens 350 is about 6.51 mm.

In some examples, an Abbe number of the fourth lens 310 is about 62.76, and a refractive index thereof is about 1.2351. An Abbe number of the fifth lens 320 is about 63.31, and a refractive index thereof is about 1.2281. Abbe numbers of the sixth lens 330 and the seventh lens 340 are both about 53.45, and refractive indexes thereof are both about 1.5604. An Abbe number of the eighth lens 350 is about 60.60, and a refractive index thereof is about 1.2651.

In some examples, the fourth lens 310 includes a fifth mirror surface and a sixth mirror surface that are disposed opposite to each other, the fifth lens 320 includes a seventh mirror surface and an eighth mirror surface that are disposed opposite to each other, the sixth lens 330 includes a ninth mirror surface and a tenth mirror surface that are disposed opposite to each other, the seventh lens 340 includes an eleventh mirror surface and a twelfth mirror surface that are disposed opposite to each other, the eighth lens 350 includes a thirteenth mirror surface and a fourteenth mirror surface that are disposed opposite to each other, all the mirror surfaces are aspheric surfaces, and a shape of the aspheric surface may be determined according to the foregoing formula (1).

For example, as shown in FIG. 9, the fifth mirror surface protrudes in a negative direction of a y-axis, a curvature radius thereof is about 12.13 mm, the sixth mirror surface protrudes in the negative direction of the y-axis, and a curvature radius thereof is about 63.40 mm.

The seventh mirror surface protrudes in a positive direction of the y-axis, a curvature radius thereof is about 6.63 mm, the eighth mirror surface protrudes in the positive direction of the y-axis, and a curvature radius thereof is about 8.29 mm.

The ninth mirror surface protrudes in the positive direction of the y-axis, a curvature radius thereof is about 14.24 mm, the tenth mirror surface protrudes in the negative direction of the y-axis, and a curvature radius thereof is about 7.02 mm.

The eleventh mirror surface protrudes in the positive direction of the y-axis, a curvature radius thereof is about 38.29 mm, the twelfth mirror surface protrudes in the positive direction of the y-axis, and a curvature radius thereof is about 5.71 mm.

The thirteenth mirror surface protrudes in the negative direction of the y-axis, a curvature radius thereof is about 4.52 mm, the fourteenth mirror surface protrudes in the negative direction of the y-axis, and a curvature radius thereof is about 12.62 mm.

Light from a photographed object is incident to the first reflection element 200 after successively passing through the first lens 110 and the second lens 120 of the first lens group 100, is incident to the second lens group 300 after being folded by 90°, successively passes through the fourth lens 310, the fifth lens 320, the sixth lens 330, the seventh lens 340, and the eighth lens 350, and then is incident to the photosensitive element 400 after passing through the infrared cut-off filter 500.

In some examples, a distance between the first lens group 100 and the first reflection element 200 is about 0.41 mm, a distance between the first reflection element 200 and the second lens group 300 is about 3.01 mm, and a distance between the second lens group 300 and the photosensitive element 400 is about 0.95 mm.

In some examples, surfaces of a plurality of lenses included in the first lens group 100 and the second lens group 300 may be aspheric surfaces, and a specific shape of the surface of the lens may be determined according to the foregoing formula (1). For example, aspheric coefficients of the plurality of lenses are shown in the following table.

TABLE 5

| | s2 | s3 | s4 | s5 | s8 | s9 | s10 |
|---|---|---|---|---|---|---|---|
| k | 0 | 0 | 0 | 0 | 0 | 0 | 0 |
| A4 | −0.000369528 | 0.00024554 | 0.000836903 | 0.000300352 | 0.0045002 | 0.00542592 | −0.00445292 |
| A6 | 0.000005 | −0.000108933 | −0.000221544 | −0.000098 | −0.00260107 | −0.00302881 | 0.000386921 |
| A8 | −0.000001 | 0.000013 | 0.000023 | 0.000008 | 0.000468948 | 0.000602616 | −0.000032 |
| A10 | 0.000000128 | 0.000001 | −0.000002 | −0.000000481 | −0.000045 | −0.000066 | 0.000003 |
| A12 | 9.81E−09 | 4.99E−08 | 8.02E−08 | 2.20E−08 | 0.000002 | 0.000004 | 0.000000292 |
| A14 | 4.79E−10 | −1.69E−09 | −2.84E−09 | −7.73E−10 | −2.94E−08 | −0.000000158 | 2.28E−08 |
| A16 | −1.45E−11 | 3.68E−11 | 6.66E−11 | 1.89E−11 | −2.40E−09 | 3.3E−09 | −9.15E−10 |
| A18 | 2.5E−13 | −4.07E−13 | −8.34E−13 | −2.5E−13 | 1.27E−10 | −3.33E−11 | 1.73E−11 |
| A20 | −1.91E−15 | 3.2E−16 | 2.02E−15 | 7.83E−16 | −2.03E−12 | 1.09E−13 | −1.18E−13 |
| A22 | 0 | 2.42E−17 | 3.87E−17 | 9.71E−18 | 0 | 0 | 0 |
| A24 | 0 | 0 | 0 | 0 | 0 | 0 | 0 |
| A26 | 0 | 0 | 0 | 0 | 0 | 0 | 0 |
| A28 | 0 | 0 | 0 | 0 | 0 | 0 | 0 |
| A30 | 0 | 0 | 0 | 0 | 0 | 0 | 0 |
| | s11 | s12 | s13 | s14 | s15 | s16 | s17 |
| k | 0 | 0 | 0 | 0 | 0 | 0 | −1 |
| A4 | −0.0113132 | −0.00248248 | 0.000104205 | 0.00875802 | 0.00793216 | −0.022741 | −0.0348705 |
| A6 | 0.00212799 | 0.000338942 | 0.000011 | −0.000709165 | 0.00151797 | −0.00469951 | 0.00731267 |
| A8 | −0.000889723 | −0.000035 | −0.000000307 | 0.00009 | −0.000718627 | 0.00851621 | −0.00143584 |
| A10 | 0.000319085 | 0.000002 | 2.96E−09 | −0.000012 | 0.000168225 | −0.00471904 | 0.000212994 |
| A12 | −0.000082 | −4.52E−08 | −3.82E−12 | 0.000001 | −0.000025 | 0.00144538 | −0.000022 |
| A14 | 1.40E−05 | 4.24E−10 | 0 | −0.000000119 | 0.000002 | −2.71E−04 | 0.000002 |
| A16 | −0.000001 | 1.02E−12 | 0 | 6.10E−09 | −1.42E−07 | 0.000032 | −7.36E−08 |
| A18 | 7.56E−08 | 0 | 0 | −1.71E−10 | 4.61E−09 | −0.000002 | 1.91E−09 |
| A20 | −1.78E−09 | 0 | 0 | 1.99E−12 | −5.68E−11 | 9.18E−08 | −2.09E−11 |
| A22 | 0 | 0 | 0 | 0 | −2.1E−13 | −1.58E−09 | −1.68E−14 |
| A24 | 0 | 0 | 0 | 0 | 0 | 0 | 0 |
| A26 | 0 | 0 | 0 | 0 | 0 | 0 | 0 |
| A28 | 0 | 0 | 0 | 0 | 0 | 0 | 0 |
| A30 | 0 | 0 | 0 | 0 | 0 | 0 | 0 |

Optical parameters of the seventh lens module 8000 shown in the following Table 6 may be obtained by setting a lens parameter, a lens group arrangement, and the like in the lens module. A focal length of the first lens group 100 is 24.68 mm, an image stabilization stroke thereof is 0.216 mm, and a ratio of the two is about 114. An adjustable distance ΔL of the second lens group 300 along the optical axis is 1.43 mm, a total track length of the lens module is 24.00 mm, and a ratio of the two is about 0.06. In the macro paragraphing mode of the lens module, a magnification rate may be 0.1 to 0.5, and an image stabilization angle may be 0.5° to 3.0°.

TABLE 6

| | | | | | Magnification | |
|---|---|---|---|---|---|---|
| | | | | | rate in macro | |
| F#(1) | F#(2) | EFL(1)/mm | EFL(2)/mm | H_{0.5}/mm | photographing | |
| 3.32 | 3.19 | 29.5 | 22.66 | 3.74 | 0.30 | |
| Object distance | | | | | | |
| in macro | | | | | | |
| photographing/mm | Δ L/mm | S1/mm | S2/mm | f1/mm | f2/mm | |
| 94.54 | 1.43 | 24.00 | 0.216 | 12.47 | −22.31 | |
| f3/mm | f4/mm | f5/mm | f6/mm | f7/mm | G1/mm | G2/mm |
| 18.02 | −12.48 | 8.20 | −5.66 | 25.75 | 24.68 | 10.11 |

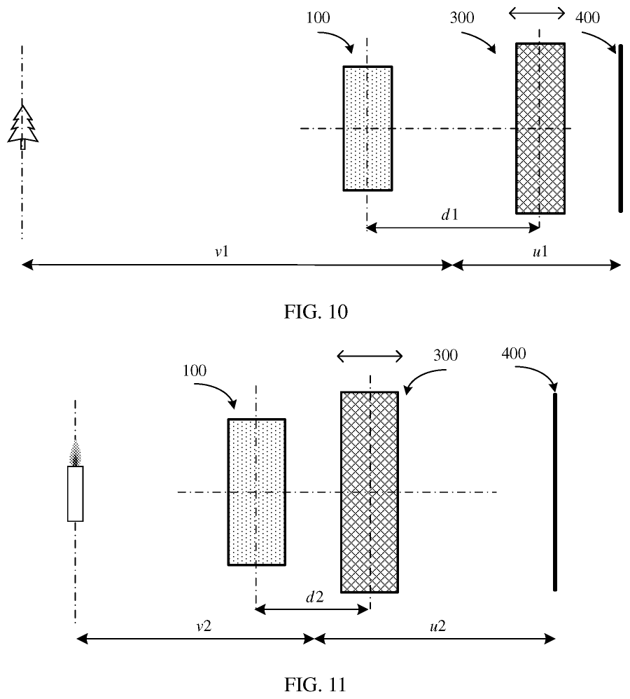

FIG. 10 and FIG. 11 are diagrams of the first lens module 2000 in a first photographing state and a second photographing state according to the present disclosure. For ease of description, the first reflection element 200 is not shown in the figure. A position of the first lens group 100 in an optical axis direction is relatively fixed, and the second lens group 300 may move close to or away from the photosensitive element 400 along the optical axis. With reference to FIG. 10 and FIG. 11, the following further describes a focus adjustment function of the lens module provided in embodiments of the present disclosure.

EFL is used to represent an effective focal length of the first lens module 2000, G1 and G2 respectively represent a focal length of the first lens group 100 and a focal length of the second lens group 300, u and v respectively represent an image distance and an object distance of the first lens module 2000, and d represents a distance between the first lens group 100 and the second lens group 300.

According to an imaging formula, both u and v are positively correlated with the EFL, and u and v are negatively correlated with each other. Further, according to an image-forming principle, the focal length EFL of the first lens module 2000 including a plurality of lenses is positively correlated with the spacing d between the first lens group 100 and the second lens group 300.

In the first photographing state shown in FIG. 10, the second lens group may move in a direction close to the photosensitive element 400. An adjusted spacing between the first lens group and the second lens group is denoted as d1, and the adjusted spacing d1 is greater than an initial spacing d0. Because d is positively correlated with the EFL, when d=d1, the EFL increases from an initial value EFL(0) to EFL(1), that is, EFL(1)>EFL(0).

In a process in which the first lens group approaches the photosensitive element, the image distance u of the lens module gradually decreases, and an adjusted image distance is denoted as u1. In this case, the adjusted image distance u1 is less than an initial value u0 of the image distance.

Both an increase of the focal length and a decrease of the image distance of the first lens module 2000 can increase the object distance thereof. In other words, adjusting the distance between the second lens group and the first lens group causes larger adjustment space for the object distance of the first lens module 2000, so that the first lens module 2000 can photograph a farther object.

In the second photographing state shown in FIG. 11, the second lens group 300 may move in a direction away from the photosensitive element 400. An adjusted spacing between the first lens group and the second lens group is denoted as d2, and the adjusted spacing d2 is less than an initial value do of the spacing. Because d is positively correlated with EFL, when d=d2, EFL decreases from the initial value EFL(0) to EFL(2), that is, EFL(2)<EFL(0).

In a process in which the second lens group 300 approaches the photosensitive element, the image distance u of the first lens module 2000 gradually decreases, and an adjusted image distance is denoted as u2. In this case, the adjusted image distance u2 is greater than the initial value u0 of the image distance.

Both a decrease of the focal length and an increase of the image distance of the first lens module 2000 can decrease the object distance thereof. In other words, adjusting the distance between the second lens group 300 and the first lens group 100 causes larger adjustment space for the object distance of the first lens module 2000, so that the first lens module 2000 can photograph a nearer object.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A lens, comprising:
a first lens group,
a first reflection element,
a second lens group, and a photosensitive element,
wherein:
the first lens group comprises one or more lenses, a distance between the first lens group and the first reflection element is fixed in a first direction, the first direction is an axial direction of the first lens group, the first lens group is configured to be movable in a first plane, and the first plane is perpendicular to the first direction;
the second lens group comprises one or more lenses, the second lens group is configured to be movable close to or away from the first reflection element in a second direction, and the second direction is an axial direction of the second lens group; and
the first reflection element and the photosensitive element are fixed relative to each other; wherein incident light is incident to the first reflection element after passing through the first lens group, is incident to the second lens group after being reflected by the first reflection element, and is incident to the photosensitive element after passing through the second lens group.

2. The lens according to claim 1, wherein the lens further comprises a first platform, the first lens group is fastened to the first platform, and the first platform is configured to drive the first lens group to move in the first plane.

3. The lens according to claim 1, wherein a focal length of the first lens group is G1, a maximum stroke of the first lens group in the first plane is 2×Ld, and G1 and Ld satisfy:
$$\frac{G 1}{L d} \geq 50.$$

4. The lens according to claim 1, wherein the lens further comprises a second platform, the second lens group is fastened to the second platform, and the second platform is configured to drive the second lens group to move close to or away from the first reflection element in the second direction.

5. The lens according to claim 1, wherein a total track length of the lens module is Lt, a maximum stroke of the second lens group in the second direction is Mv, and Lt and Mv satisfy:
$$0.01 \leq \frac{M v}{L t} \leq 0 \text{.40} .$$

6. The lens according to claim 1, wherein the first lens group has a positive focal power.

7. The lens according to claim 1, wherein an optical axis of the first lens group is perpendicular to an optical axis of the second lens group.

8. The lens according to claim 1, wherein the lens further comprises a third lens group, the third lens group comprises one or more lenses, the third lens group is located on a side that is of the second lens group and that is close to the first reflection element, and the third lens group and the first reflection element are fixed relative to each other.

9. The lens according to claim 1, wherein the lens further comprises a fourth lens group, the fourth lens group comprises one or more lenses, the fourth lens group is located on a side that is of the second lens group and that is away from the first reflection element, and the fourth lens group and the first reflection element are fixed relative to each other.

10. The lens according to claim 1, wherein the lens further comprises a second reflection element, the second reflection element is located on the side that is of the second lens group and that is away from the first reflection element, and the second reflection element is disposed close to the photosensitive element.

11. The lens according to claim 1, wherein the lens further comprises an infrared cut-off filter, the infrared cut-off filter is located on the side that is of the second lens group and that is away from the first reflection element, and the infrared cut-off filter is disposed close to the photosensitive element.

12. An electronic device, comprising a lens, wherein the lens comprises a first lens group, a first reflection element, a second lens group, and a photosensitive element, wherein:
the first lens group comprises one or more lenses, a distance between the first lens group and the first reflection element is fixed in a first direction, the first direction is an axial direction of the first lens group, the first lens group is configured to be movable in a first plane, and the first plane is perpendicular to the first direction;
the second lens group comprises one or more lenses, the second lens group is configured to be movable close to or away from the first reflection element in a second direction, and the second direction is an axial direction of the second lens group; and
the first reflection element and the photosensitive element are fixed relative to each other; wherein
incident light is incident to the first reflection element after passing through the first lens group, is incident to the second lens group after being reflected by the first reflection element, and is incident to the photosensitive element after passing through the second lens group.

13. The electronic device according to claim 12, wherein a focal length of the first lens group is G1, a maximum stroke of the first lens group in the first plane is 2×Ld, and G1 and Ld satisfy:
$$\frac{G 1}{L d} \geq 50.$$

14. The electronic device according to claim 12, wherein a total track length of the lens module is Lt, a maximum stroke of the second lens group in the second direction is Mv, and Lt and Mv satisfy:
$$0.01 \leq \frac{M v}{L t} \leq 0.40 .$$

15. The electronic device according to claim 12, wherein the first lens group has a positive focal power.
